(19) United States
(12) Patent Application Publication
(10) Pub. No.: US 2025/0100227 A1
(43) Pub. Date: Mar. 27, 2025

(54) EXPOSURE STRATEGY AT SCAN FIELD BOUNDARIES

(71) Applicant: EOS GMBH ELECTRO OPTICAL SYSTEMS, Krailling (DE)

(72) Inventors: Stefan GRÜNBERGER, Schondorf (DE); Stephan TENBRINK, MüNCHEN (DE)

(21) Appl. No.: 18/727,666

(22) PCT Filed: Jan. 10, 2023
(86) PCT No.: PCT/EP2023/050446

§ 371 Date: Jul. 9, 2024

(30) Foreign Application Priority Data
Jan. 10, 2022 (DE) 10 2022 200 167.2

(51) Int. Cl. B29C 64/393; B29C 64/153; B29C 64/268; B29K 105/00; B33Y 10/00; B33Y 30/00; B33Y 50/02

(52) U.S. Cl. CPC B29C 64/393; B29C 64/268; B33Y 30/00; B33Y 50/02; B29C 64/153; B29K 2105/251; B33Y 10/00

(57) ABSTRACT

Disclosed is a method for generating a control data set for an energy input device of an additive manufacturing device. The method includes accessing computer-based model data of an object cross-section of the object to be manufactured, and generating a data model of a region of a building material layer to be solidified, where the region to be solidified is divided into a plurality of subregions. At least a first subregion and a second subregion adjoin each other at a boundary, and locations in the first subregion are scanned at a time coordinated with locations in the second subregion Further, the control data set for the energy input device is generated taking into account the data model generated previously.

The present invention relates to a method for controlling an energy input device of an additive manufacturing device, a correspondingly adapted additive manufacturing method, a corresponding device for controlling an energy input device of an additive manufacturing device, a correspondingly adapted additive manufacturing device, and an object manufactured by the correspondingly adapted additive manufacturing method.

Additive manufacturing devices and associated methods are generally characterized by the fact that objects are produced by solidifying a shapeless building material layer by layer. Solidification can be achieved, for example, by supplying thermal energy to the building material by irradiating it with electromagnetic radiation or particle radiation (e.g. laser sintering (SLS) or laser melting (SLM) or electron beam melting). The devices and methods originally used in prototype construction are now used for series production, for which the term “additive manufacturing” has become commonplace.

In additive manufacturing in particular, it is important not only to produce the objects with high precision, but also within a short production time. Here, the production time can be reduced if several beams, e.g. laser beams, are used simultaneously to solidify the locations corresponding to one or more object cross-sections in a layer.

WO 2016/110440 A1 describes a corresponding device in which different laser beams or scanners are assigned to different regions of a layer.

In such multi-scanner systems, a build area is often divided into several sections, with each of the scanners or laser beams being assigned to one of the sections so that this scanner can scan the building material to solidify it in this section.

The inventors have found that in the boundary region of the exposure zones of different laser beams, i.e. where the sections assigned to the laser beams adjoin each other, the melting behavior or solidification behavior of the building material is slightly different than in other regions. In particular, the inventors were able to determine that slight inhomogeneities in the component properties occur at the boundary line, for example degraded mechanical properties.

The inventors were also able to observe that inhomogeneities can also occur when using only one laser beam, namely when two layer regions to be solidified that adjoin in the build plane are exposed with a time lag from each other.

It is therefore an object of the present invention to provide a method and a device by means of which objects can be produced with improved quality, in particular in a short time, by means of an additive manufacturing process.

The problem is solved by a computer-aided method for generating a control data set for an energy input device according to claim 1, a method for controlling an energy input device of an additive manufacturing device according to claim 15 and a device for controlling an energy input device of an additive manufacturing device according to claim 32. Further developments of the invention are described in the dependent claims.

According to the invention, a computer-aided method for generating a control data set for an energy input device of an additive manufacturing device for manufacturing a three-dimensional object by means of the same,
wherein the additive manufacturing device is adapted to manufacture the object by applying a building material layer by layer and solidifying the building material in a build area by means of the energy input device by supplying radiation energy to solidification positions in each layer which are associated with the cross-section of the object to be manufactured in this layer,
wherein the energy input device comprises a number of beam emitters above the build area from which a number of beams are directed to the build area,
comprises the following steps:
a first step (S1) of accessing computer-based model data of an object cross-section of the object to be manufactured,
a second step (S2) of generating a data model of a region of a building material layer to be solidified for the manufacture of the object cross-section,
wherein in the data model, scanning of locations of the region to be solidified by moving a beam along a plurality of trajectories in the build area is specified,
wherein in the data model the region of the building material layer to be solidified is divided into a plurality of subregions to be solidified, to each of which subregions a beam is directed,
wherein there are at least a first subregion to be solidified and a second subregion to be solidified, which adjoin each other at a boundary in the build area,
wherein it is specified that locations to be solidified in the first subregion to be solidified are scanned at a time coordinated with locations to be solidified in the second subregion to be solidified, and
a third step (S3) in which the control data set for the energy input device is generated taking into account the data model generated in the second step.

In particular, the method can be carried out entirely by a computer that performs all method steps independently without the intervention of an operator.

Additive manufacturing devices and methods to which the present invention relates are those in which energy is selectively supplied as electromagnetic radiation or particle radiation to a layer of a shapeless building material. Here, the working plane (also referred to as the build plane) is a plane in which the upper side of the layer to which the energy is supplied is located. In doing so, the energy input device can, for example, comprise a laser. The radiation supplied to the building material heats it and thereby causes a sintering or melting process. In particular, the present invention relates to laser sintering and laser melting devices and the associated methods. In laser sintering or laser melting, an energy input device can comprise, for example, one or more gas or solid-state lasers or any other type of laser such as laser diodes, in particular VCSEL (Vertical Cavity Surface Emitting Laser) or VECSEL (Vertical External Cavity Surface Emitting Laser). In particular, the diode lasers can also be arranged in a row or in matrix form.

Although the invention can be applied in connection with plastic-based building material as well as in connection with metal-based building material, an application of the invention in connection with additive manufacturing methods and devices in which a plastic-containing building material is used, for example a polymer-based building material, i.e. a building material with a polymer content of 55% by volume or more, in particular a polymer powder, is of particular advantage.

It should be noted here that an additive manufacturing device according to the invention can be used to produce not only one object, but also several objects simultaneously by solidifying the cross-sections of several objects in one layer. When the present application refers to the production of an object, it is understood that the respective description is equally applicable to additive manufacturing methods and devices in which several objects are produced at the same time.

In this application, the term “beam” is used instead of “ray” in order to express that the diameter of the beam does not necessarily have to be very small, in particular if the radiation impinges on the building material in an oblique way or if radiation is used that is deliberately intended to cover a larger area when it impinges on the building material.

A beam emitter can, for example, be a scanner with one or more galvanometer mirrors for deflecting a laser beam. Under certain circumstances, several different beams can also be assigned to one and the same beam emitter or scanner, which beams are, for example, alternately directed to the build plane by this beam emitter, although normally exactly one beam to be directed to the build plane is assigned to one beam emitter. It should be noted here that in the present application the term “number” is always to be understood in the sense of “one or more”.

In the method according to the invention, in order to produce at least a number of cross-sections of the object, preferably for producing the entire object, the energy input device is in each case controlled based on the generated data model of an object cross-section in such a way that the energy input device supplies the energy required for solidifying the building material to the locations to be solidified corresponding to the object cross-section. In doing so, in particular, the temporal sequence in which the locations are to be solidified, i.e. scan lines or trajectories in the build plane along which the beam is to be moved, is specified and the number of beam emitters for moving the beams assigned to them is controlled accordingly.

It should be mentioned that different beams can be used in different subregions or that one and the same beam can be used in these different subregions or even in all subregions.

A trajectory of a beam specified in a data model provides a path of a beam in the build plane when directing the beam onto the building material. A trajectory of a beam specified when controlling the energy input device corresponds to a solidification path in the build plane along which the building material is to be solidified by displacing the melt pool in a direction substantially parallel to the build plane. In the process, so much energy is supplied to the building material, which is preferably in powder or pasty form, at a solidification position by the beam that the building material melts at this location as a result of a melting temperature being exceeded, so that it is then no longer shapeless in its cooled state, but is present as a solid body. Here, solidification paths are regions in which solidification is actually achieved when the building material is scanned by the beam and not merely a preheating of the still shapeless material or a post-heating of already melted material. In particular in additive manufacturing methods in which plastic-based building material is used and to which the invention preferably relates, preheating of the building material to a working temperature just below a melting point of the building material can take place before a beam is directed onto the building material for (partial) melting of the same.

There are cases in which one or more changes of direction take place when moving a beam along the solidification path, in particular the solidification path is geometrically present as a curved line of a certain width. Preferably, however, the invention is directed to rectilinear solidification paths and trajectories, at least rectilinear within the framework of the circumstances of the apparatus.

When this application refers to the orientation of a trajectory in the build plane, this refers to the direction in which a straight line covering the trajectory extends. This is distinguished from a scanning direction of a trajectory, which defines the direction in which the beam is moved along the straight line.

When scanning the locations of a layer to be solidified, a distinction is usually made between an inner region and an edge region (often an edge line whose width roughly corresponds to the diameter of the beam) of an object cross-section. In this process, the area of the inner region is solidified by moving the beam along parallel or substantially parallel trajectories. The area is hatched (“hatching”), so to speak, which is why the individual trajectories are also referred to as hatch lines. In the method according to the invention for generating a control data set, a trajectory can be a so-called “hatch line” when scanning an inner region of an object cross-section or an edge line mentioned above (also referred to as a contour line).

The computer-based model data, which is accessed in the first step, contains a geometric description (of a cross-section) of the object, i.e. in particular a three-dimensional CAD model, although there are also other possibilities for geometric description, e.g. a description by a parameter set and a construction rule. In this context, it is only important that the model data describe the geometric shape of at least one cross-section of an object to be manufactured, to which a layer of the building material, preferably exactly one layer, is assigned.

Even if the second step refers to the generation of a data model of an object cross-section, it is understood that a data model can also be generated which refers to a plurality of object cross-sections, i.e. specifies a scanning of locations of the object cross-section with a number of beam bundles in accordance with the invention for at least one, preferably a plurality, particularly preferably all of these object cross-sections. The prerequisite for this is that the corresponding computer-based model data of these object cross-sections is accessed in the first step. In particular, data models can also be generated that refer to a plurality of object cross-sections that are assigned to different building material layers. As the case may be, a data model of the entire object can also be generated.

The method according to the invention for generating a control data set can counteract a distortion or shrinkage that occurs at the boundary between the first and second subregion to be solidified.

Preferably, locations to be solidified at the boundary in the first subregion to be solidified can be scanned with a previously determined material- and/or process-specific maximum time interval to locations to be solidified at the boundary in the second subregion to be solidified.

Further preferably, locations to be solidified in the first subregion to be solidified can be scanned with a maximum time interval to locations to be solidified in the second subregion to be solidified, which maximum time interval is less than or equal to 200 ms, preferably less than or equal to 100 ms, still further preferably less than or equal to 50 ms, still further preferably less than or equal to 20 ms, still further preferably less than or equal to 10 ms.

Preferably, the trajectories can extend substantially parallel to each other in the first and second subregions to be solidified.

Further preferably, the trajectories can extend at an angle to the boundary in the first and second subregions to be solidified. Here, the angle is different from 0° and can, in particular, be 90°.

Further preferably, the trajectories can extend substantially parallel to the boundary in the first and second subregions to be solidified.

Further preferably, the trajectories in the two subregions to be solidified can be arranged mirror-symmetrically to the boundary, wherein preferably the scanning directions of trajectories in the two subregions to be solidified, which trajectories are mirror-symmetrical to the boundary, are also mirror-symmetrical.

Preferably, pairs of locations, preferably all pairs of locations, on both sides of the boundary, the distance between which is less than 1000 times, more preferably less than 500 times, even more preferably less than 100 times, even more preferably less than 50 times, even more preferably less than 10 times, even more preferably less than 5 times, even more preferably less than 3 times the beam width of the beam in the first subregion to be solidified, can be solidified at a time coordinated with one another.

The beam width can be considered here as the extent of a beam on the build area perpendicular to the direction of movement of the beam. Using the procedure described above, locations on both sides of the boundary that are strongly influenced by temperature changes beyond the boundary can be scanned at a time coordinated with each other.

The method can preferably be applied to object cross-sections that comprise a downwardly facing surface region of the object during manufacture, preferably additionally in the solidification of the two object cross-sections directly above such object cross-sections, still more preferably additionally in the solidification of four object cross-sections directly above an object cross-section having a surface region facing downward during manufacture.

Preferably, a scanning of the locations of the region of the building material layer to be solidified is specified subregion by subregion,
wherein it is specified that after scanning the locations of the first subregion to be solidified at the boundary, preferably after scanning all locations of the first subregion to be solidified, scanning of the second subregion to be solidified, preferably scanning of the locations of the second subregion to be solidified at the boundary, is started only after the end of an interruption period Δt,
wherein if the interruption period Δt exceeds a permissible interruption time span tₘₐₓ, the scanning of the locations of the region to be solidified is specified such
that a distance D′ between the trajectory closest to the boundary in the first subregion to be solidified and the trajectory closest to the boundary in the second subregion to be solidified is smaller than an average distance D between the trajectories in the first subregion to be solidified and/or between the trajectories in the second subregion to be solidified; and/or
all locations in the first subregion to be solidified whose distance to the boundary is smaller than a predefined minimum distance are scanned again before the start of the scanning or during scanning of the locations of the second subregion to be solidified.

In other words, in this procedure there are two adjoining subregions to be solidified, in which after scanning the locations of the first subregion to be solidified, it is not immediately started with the scanning of the locations of the second subregion to be solidified. During the interruption period, locations in the build area that are not located in the first and second subregions to be solidified can be scanned in particular.

Preferably, the interruption period is assessed as the time period between the end of the scanning of locations at the boundary in the first subregion to be solidified and the beginning of the scanning of locations in the second subregion to be solidified, more preferably of locations at the boundary in the second subregion to be solidified.

In particular, in this procedure, the locations in the first and second subregions to be solidified can be scanned with one and the same beam.

The permissible interruption time span tₘₐₓ is a time period within which cooling (temperature reduction) of the locations scanned in the first subregion to be solidified takes place, but the amount of temperature reduction is considered harmless for the homogeneity of the object at the boundary between the subregions to be solidified. What can still be considered harmless can be determined, for example, by carrying out a few preliminary tests with the targeted building material before starting the actual manufacturing process with the additive manufacturing device. As a result of the preliminary tests, for example, the value of the permissible interruption time span tₘₐₓ can then be specified as a parameter (e.g. at an input interface of the device (of the computer) by means of which the method according to the invention is carried out) when carrying out the method according to the invention. Possible values of the interruption time span are generally below 120 ms, preferably below 100 ms and/or above 20 ms, preferably above 50 ms.

The minimum distance to the boundary is a distance that is determined perpendicular to the extension of the boundary in each case. In the first subregion to be solidified, it may also be possible to scan again locations that are at a greater distance to the boundary than the minimum distance. According to the invention, however, substantially all locations that are less than the minimum distance from the boundary should be scanned again. The minimum distance can also be determined by preliminary tests with the targeted building material before the start of the actual manufacturing process with the additive manufacturing device and then, for example, be specified as a parameter when the method according to the invention is carried out (e.g. at an input interface of the device (of the computer) by means of which the method according to the invention is carried out).

In particular if the trajectories in the first and second subregions are substantially parallel to the boundary, it is advisable to select a distance (D′) between the trajectory closest to the boundary in the first subregion to be solidified and the trajectory closest to the boundary in the second subregion to be solidified that is smaller than an average distance (D) between the trajectories in the first subregion to be solidified and/or between the trajectories in the second subregion to be solidified. Preferably, this is done if the exceedance of the interruption time span does not exceed a threshold value determined in advance (e.g. 5 s).

A distance between two adjacent trajectories that are substantially parallel to each other can be defined here as a minimum distance between the two trajectories, i.e. as the minimum distance that two points, one of which lies on one trajectory and the other of which lies on the other trajectory, can have. Substantially parallel here means that the distance only varies within narrow boundaries, e.g. its value varies by less than 10%, preferably varies by less than 5%, even more preferably varies by less than 2%.

Alternatively, the mean value of all distances between the points of the first trajectory and the second trajectory can be used as the distance between two adjacent trajectories that are substantially parallel to each other. A distance between a point on a trajectory and the neighboring trajectory can here be defined as the length of a distance along a perpendicular line from the neighboring trajectory to this point. The average distance between the trajectories of a subregion to be solidified can be the mean value of the distances between two adjacent trajectories of the subregion to be solidified, provided that the distance between the trajectories within a subregion is not constant anyway.

If, after completion of the solidification of the first subregion to be solidified, the solidification of the locations in the second subregion to be solidified at the boundary only starts after an interruption period Δt, then the material in the first subregion to be solidified can cool down so much during the interruption period that shrinkage or distortion occurs, in particular at the edges of the first subregion to be solidified. The procedure just described ensures that the already solidified building material in the first subregion to be solidified coalesces with the still unsolidified building material at the boundary, which counteracts the distortion. This is achieved, for example, by scanning locations near the boundary in the first subregion to be solidified again in order to increase the temperature there if the time between the end of the scanning of the first subregion to be solidified and the start of the scanning of the second subregion to be solidified is too long. The temperature can be increased at locations close to the boundary and, as a result, distortion can be counteracted.

It should be emphasized here that locations in the first subregion to be solidified cannot be scanned again simply by moving a beam along a trajectory located completely or partially in the first subregion to be solidified. Since the beam is not point-shaped, but always has a certain extent, building material in the first subregion to be solidified can also be scanned by moving a beam along a trajectory that is located completely or partially within the second subregion to be solidified close to the boundary. In still other words, locations in the first subregion to be solidified whose distance to the boundary is less than a predetermined minimum distance can be scanned by moving a beam along a number of trajectories that extend in the first subregion to be solidified and/or in the second subregion to be solidified.

When the locations in the first working region are scanned again, a similar amount of energy is preferably supplied to the building material as when these locations were scanned for the first time. In some cases, however, it can already be sufficient to supply a smaller amount of energy to the building material, e.g. by reducing the power density in the beam or by changing the focus diameter or by increasing the speed of movement of the beam across the build area.

Of course, the actual time period which ultimately lies between the end of the (initial) scanning of the first subregion to be solidified and the beginning of the scanning of the second subregion to be solidified can be extended as a result of the repeated scanning of locations in the first subregion to be solidified. In the procedure according to the invention, however, the “original” time period that would exist without repeated scanning of locations in the first subregion to be solidified is determined for the decision as to whether locations in the first subregion to be solidified are scanned again.

In particular, a distortion at the boundary can also be reduced by selecting a distance (D′) between the trajectory closest to the boundary in the first subregion to be solidified and the trajectory closest to the boundary in the second subregion to be solidified smaller than an average distance (D) between the trajectories in the first subregion to be solidified and/or between the trajectories in the second subregion to be solidified.

For example, the distance of n trajectories closest to the boundary in the second subregion, wherein a natural number is greater than zero, could also be set to the reduced distance (D′).

Further preferably, the more the interruption period Δt exceeds the permissible interruption time span t max, the smaller the distance D′ between the trajectory closest to the boundary in the first subregion to be solidified and the trajectory closest to the boundary in the second subregion to be solidified and/or the higher the value for the minimum distance can be specified.

The way in which the distance between two trajectories and/or the minimum distance is to be adapted to the extent to which the permissible interruption time span tₘₐₓ is exceeded can in turn be determined by preliminary tests with the targeted building material before the start of the actual manufacturing process with the additive manufacturing device.

For example, with a permissible interruption time span tₘₐₓ of 50 ms, for polyamide as the building material and with an interruption period that is greater than or equal to 7 s and/or less than or equal to 15 s, the predetermined minimum distance can be between 250 μm and 300 μm, and with an interruption period that is greater than or equal to 1 s and/or less than or equal to 7 s, the predetermined minimum distance can be between 100 μm and 250 μm. Accordingly, for an interruption period that is greater than or equal to 50 ms and/or less than or equal to 1 s, a distance between the trajectory closest to the boundary in the first subregion to be solidified and the trajectory closest to the boundary in the second subregion to be solidified can be selected between 150 μm and 225 μm if it is assumed that the average distance between the trajectories in the first and second subregions is 20 μm in each case.

The procedure is based on the idea that the longer the interruption period, the greater the degree of cooling of the already solidified locations (the value of the temperature reduction).

The way in which the minimum distance is to be increased depending on the extent to which the permissible interruption time span tₘₐₓ is exceeded or the distance between the trajectory closest to the boundary in the first subregion to be solidified and the trajectory closest to the boundary in the second subregion to be solidified is to be reduced can in turn be determined by preliminary tests with the targeted building material before the start of the actual manufacturing process with the additive manufacturing device.

A minimum distance adapted to the extent to which the permissible interruption time span is exceeded can be determined or specified for the generation of the data model. Accordingly, a distance between the trajectory closest to the boundary in the first subregion to be solidified and the trajectory closest to the boundary in the second subregion to be solidified can be reduced in the data model.

In accordance with the minimum distance, locations in the first subregion to be solidified are scanned again when the second subregion to be solidified is scanned; in particular, locations in the first subregion to be solidified that are at a distance from the boundary that is smaller than the minimum distance are scanned again.

Even more preferably, when specifying the value of the distance D′ between the trajectory closest to the boundary in the first subregion to be solidified and the trajectory closest to the boundary in the second subregion to be solidified and/or when specifying the value of the minimum distance, a linear, logarithmic or exponential dependence of the distance D′ and/or the minimum distance on the extent to which the permissible interruption time span tₘₐₓ is exceeded can be used as a basis.

The exact functional relationship can be determined by preliminary tests with the targeted building material before starting the actual manufacturing process with the additive manufacturing device and then taken into account when carrying out the method according to the invention.

Furthermore, the first subregion to be solidified and the second subregion to be solidified can be a first section and a second section of a contour line of the object cross-section.

If a first section and a second section of a contour line of the object cross-section are assigned to the first subregion to be solidified and the second subregion to be solidified, this automatically means that the first and second sections adjoin each other. Since the edge region has at least a width that corresponds approximately to the diameter of the beam, the boundary is not point-shaped in this case either. In particular, the first section of the contour line is scanned with a first trajectory and the second section of the contour line is scanned with a second trajectory.

Avoiding inhomogeneities in the material is particularly important in the edge region of an object. On the one hand, inhomogeneities are usually optically visible in the edge region, and on the other hand, it is the edge region of an object that interacts with other objects, so that inhomogeneities in the edge region often lead to premature wear. Applying the method according to the invention, in which all locations in the first subregion whose distance to the boundary is less than a predetermined minimum distance, to the edge region of an object is therefore particularly advantageous.

A computer-aided method according to the invention for generating a control data set for an energy input device of an additive manufacturing device for manufacturing a three-dimensional object by means of the same,
wherein the additive manufacturing device is adapted to manufacture the object by applying a building material layer by layer and solidifying the building material in a build area by means of the energy input device by supplying radiation energy to solidification positions in each layer that are associated with the cross-section of the object to be manufactured in this layer,
wherein the energy input device comprises a first beam emitter above the build area, from which a first beam is directed to the build area, and a second beam emitter, from which a second beam is directed to the build area,
wherein the first beam emitter is assigned a first working region in the build area to which the first beam can be directed, and the second beam emitter is assigned a second working region in the build area to which the second beam can be directed,
wherein the first and second working regions adjoin each other at a boundary, comprises:
a first step (S1) of accessing computer-based model data of at least a cross-section of the object to be manufactured,
a second step (S2) of generating at least a data model of a region of a building material layer to be selectively solidified for the manufacture of the at least one object cross-section,
wherein in the data model, a scanning of locations of the region to be selectively solidified in the first and second working regions by moving the first and second beams, respectively, along a plurality of trajectories in the build area is specified,
wherein it is specified that locations to be solidified in the first working region are scanned at a time coordinated with locations to be solidified in the second working region, and
a third step (S3) in which the control data set for the energy input device is generated taking into account the data model generated in the second step.

By means of this method for generating a control data set, it is possible to generate a respective control data set for the control device of an energy input device according to the invention in order to carry out the method according to the invention for controlling an energy input device in its respective variants.

As a rule, a control data set generated according to the invention is processed by a control device of an energy input device in order to carry out a corresponding layer-by-layer additive manufacturing method of objects by means of a layer-by-layer additive manufacturing device in which the control device is integrated or to which the control device is assigned. In particular, the control device can be a unit within a control unit that controls a manufacturing process in an additive manufacturing device.

Nevertheless, it should be emphasized that the control device can also be present outside the control unit in the same way and can exchange signals with the additive manufacturing device, in particular with the energy input device, via a network.

The individual components of the control device or the entire control device can be implemented by software alone or by hardware alone or by means of a mixture of hardware and software. Interfaces do not necessarily need to be designed as hardware components, but can also be implemented as software modules. Interfaces can also consist of both hardware and software components, for example in the form of a standard hardware interface that is specially configured by software for the specific application. In addition, several interfaces can also be combined in a common interface, for example an input-output interface. In particular, if the control device is implemented solely by means of software, the control device can be present in the form of a computer program. Preferably, for a manufacturing process such a computer program is then executed by the additive manufacturing device in its control device.

In a method according to the invention for controlling an energy input device of an additive manufacturing device for manufacturing a three-dimensional object by means of the same, the additive manufacturing device is arranged to manufacture the object by applying a building material layer by layer and solidifying the building material in a build area by means of the energy input device by supplying radiation energy to solidification positions in each layer which are associated with the cross-section of the object in this layer, the energy input device comprises a first beam emitter above the build area from which a first beam is directed to the build area, and a second beam emitter from which a second beam is directed to the build area, the first beam emitter is assigned a first working region in the build area to which the first beam can be directed, and the second beam emitter is assigned a second working region in the build area to which the second beam can be directed, the first and second working regions adjoining each other at a boundary, the solidification positions of a layer in the first and second working regions are each scanned by moving the first or second beams, respectively, along a plurality of trajectories in the build area, and the energy input device is controlled such that locations to be solidified in the first working region are scanned at a time coordinated with locations to be solidified in the second working region.

In this context, it is assumed that the locations to which a beam can be directed by means of a beam emitter during an additive manufacturing process are defined by constructive measures (by means of hardware and/or software). In this context, the region of the build area in which these locations are located is regarded as the working region assigned to the beam emitter. However, this also means that the corresponding beam emitter cannot direct a beam to other locations of the build area without first making constructive changes (by means of hardware and/or software). In practice, the working regions can be limited by the control software of the beam emitters. In other words, without such a limitation by software, two beam emitters would often be able to reach individual subareas of the build area or even the entire build area together.

Although the invention preferably relates to the presence of two beam emitters, it is equally applicable in cases where more than two beam emitters are present, and in particular also where more than two working regions are present.

In this context, the working regions preferably have a trapezoidal shape, even more preferably a parallelogram shape, still more preferably a rectangular shape. Further preferably, the working regions adjoin one another in such a way that two sides of the first working region are covered by two straight lines, which also cover two sides of the second working region.

In particular, in the method according to the invention for controlling an energy input device, a trajectory is understood to be a so-called “hatch line” when scanning an inner region of an object cross-section.

It was found that the described procedure can reduce the local shrinkage at the boundary between the working regions of the beam emitters (scanners) that occurs in the prior art. The inventors attribute this to the fact that the described procedure avoids large temperature differences in the building material near the boundary between the two working regions, thereby ensuring sufficient coalescence with the building material beyond the boundary.

The method according to the invention is preferably used for solidifying cross-sections of the object that cover the boundary between the first and second working regions.

Especially when object cross-sections to be solidified cover the boundary, it is important to coordinate the scanning of locations on both sides of the boundary, as inhomogeneities then occur in the solidified material inside an object to be manufactured.

Preferably, locations to be solidified at the boundary in the first working region are scanned with a previously determined material- and/or process-specific maximum time interval to locations to be solidified at the boundary in the second working region.

The described procedure implements a time coordination in the scanning of the building material on both sides of the boundary in that a solidification position in the first working region and a solidification position in the second working region are scanned with a time difference that is less than a permissible maximum time difference. Since temperature differences occurring in the building material near the boundary are influenced to a large extent by how good the thermal conductivity of the building material is, the maximum time difference (the maximum time interval) depends on the building material used. As a rule, the thermal conductivity properties of the building material are known. However, the thermal conductivity properties of the building material (possibly at different temperatures and/or depending on the melting/solidification state) can also be investigated by carrying out a limited number of preliminary tests. In particular, the temperature change of the building material caused by a beam impinging on the building material can also be taken into account. This can be important insofar as, when using polymer-based building material, for example, only a small proportion of the energy required for melting is supplied by the beam, as the building material has been heated in a large area to a working temperature just below a melting temperature by an areal heating. When using metal-based building material, the temperature increase caused by the beam is usually considerably greater, which also leads to a different thermal behavior.

Preferably, locations to be solidified in the first working region are scanned with a maximum time interval to locations to be solidified in the second working region, which time interval is less than or equal to 200 ms, preferably less than or equal to 100 ms, even more preferably less than or equal to 50 ms, even more preferably less than or equal to 20 ms, even more preferably less than or equal to 10 ms.

Regardless of the fact that the type of building material has an influence on the extent to which the time of scanning of the building material on both sides of the boundary must be coordinated with each other, it was shown that local shrinkage can generally be sufficiently avoided if the scanning of locations on both sides of the boundary takes place with a time difference that is less than 200 ms, which is then understood to mean “coordinated with each other in time”.

Preferably, locations to be solidified in the first working region are scanned substantially at the same time as locations to be solidified in the second working region that are symmetrical with respect to the boundary.

The term “substantially at the same time” refers here to a time interval of less than 5 ms. Of course, this time interval does not need to be constant, but can vary over time as long as the time interval of 5 ms is not exceeded.

Preferably, the trajectories extend substantially parallel to each other in the first and second working regions.

Preferably, the trajectories in the two working regions each extend parallel or substantially parallel to each other. The term “substantially parallel” is intended to express that the orientations of two neighboring trajectories can have an angle to each other that is less than or equal to 5°.

Further preferably, the trajectories in the first and second working regions extend at an angle to the boundary.

Even if any value other than 0° or 180° can in principle be selected for the angle, preferably an angle of 90° is selected.

Further preferably, the trajectories in the first and second working regions extend substantially parallel to the boundary.

The term “substantially parallel to the boundary” is intended to express that the extension direction of the trajectories deviates by a maximum of 5° from the extension direction of the boundary. Preferably, the trajectories extend exactly parallel to the boundary within the framework of the boundary conditions specified by the apparatus.

If neighboring trajectories are scanned in opposite directions in each of the two working regions, the specified procedure ensures that the transition to the following trajectory at the boundary is substantially at the same time in both working regions.

If neighboring trajectories are scanned in the same direction in each of the two working regions, then either the start points in both working regions are placed at the boundary when the trajectories are scanned, or the end points in both working regions are placed at the boundary when the trajectories are scanned. In this way, it is also possible to ensure that locations in the layer that are symmetrical to each other with respect to the boundary are scanned at substantially the same time.

Further preferably, the trajectory tracing direction in the second working region is symmetrical to the trajectory tracing direction in the first working region with respect to the boundary.

If the trajectories in each of the two working regions extend substantially parallel, the trajectory tracing direction is the direction in which the trajectories in each of the working regions are scanned in succession, i.e. the trajectory tracing direction is in particular perpendicular to the trajectories. Normally, in doing so, trajectories that are located next to each other are scanned directly one after the other in time. This coordination in time of the scanning sequence of the trajectories on both sides of the boundary can ensure that the time interval between the scanning of locations on both sides of the boundary remains within limits. In particular, strong variations in this time interval can be avoided.

Further preferably, both in the first working region and in the second working region, the trajectory tracing direction points away from the boundary.

If the trajectories extend substantially parallel to the boundary in the first and second working regions, then a trajectory tracing direction, i.e. a direction in which the trajectories are scanned one after the other, is substantially perpendicular to the boundary in both working regions. If both trajectory tracing directions then point away from the boundary, this means nothing but that the trajectories are scanned-preferably at the same time-starting at the boundary. This procedure is a particularly good way of ensuring that locations in the layer that are symmetrical with respect to the boundary are scanned at substantially the same time. If, when scanning the trajectories one after the other over time, the trajectories are scanned slightly faster in one working region due to a slightly different scanning speed or trajectory length, then the variant of the procedure just described results in that a larger time interval when scanning locations that are symmetrical to the boundary only occurs for trajectories that are further away from the boundary. However, if a location to be solidified is at a greater distance from the boundary, the influence on the temperature of the building material beyond the boundary is not as great when this location is solidified.

Further preferably, in the event that the trajectories extend substantially perpendicular to the boundary in the first and second working regions, the trajectory tracing direction can be selected such that trajectories whose center (in the direction of the course of the trajectories) is at a greater distance from the boundary are scanned after trajectories whose center (in the direction of the course of the trajectories) is at a smaller distance from the boundary.

This can lead to a more homogeneous solidification, especially in the case of object cross-sections whose extent perpendicular to the boundary is different in the two working regions and changes monotonically along the boundary, preferably across the entire object cross-section, in the progress. The different extents of the object cross-section in the two working regions leads to different time durations in the two working regions required for scanning. This complicates the coordination in time of the scanning and can tend to lead to a considerable increase in the time interval between the scanning of opposite locations with respect to the boundary in those regions of the cross-section where the extent perpendicular to the boundary is very different. In the procedure just described, such regions are scanned as late as possible so that in regions in which the extent of the cross-section perpendicular to the boundary is not so great, the time interval of the scanning of opposite locations with respect to the boundary is not (yet) so great.

Further preferably, the trajectories in the two working regions are arranged symmetrically with respect to the boundary, wherein preferably the scanning directions of trajectories in the two working regions, which trajectories are symmetrical with respect to the boundary, are also symmetrical.

By symmetrical arrangement of the trajectories, it is meant that the directions in which the trajectories extend on both sides of the boundary are symmetrical to each other. The symmetrical arrangement of the trajectories means that particularly homogeneous heating and cooling of the building material can be ensured. If the directions of movement of the first and second beams are also selected to be symmetrical to each other when scanning the trajectories in the first and second working regions, the homogeneity can be improved even further.

Preferably, a waiting time can be inserted before and/or during and/or after the scanning of a number of trajectories in one of the two working regions.

In the case of object cross-sections whose extent perpendicular to the boundary is different in the two working regions, the time duration required for scanning the trajectories may vary. This can lead to the time interval between the scanning of locations opposite each other with respect to the boundary becoming large over time. This can be counteracted by inserting waiting times. In particular, the insertion of waiting times can ensure symmetrical scanning of trajectories on both sides of the boundary, i.e. substantially simultaneous scanning of locations that are symmetrical with respect to the boundary. For this purpose, for example, the waiting time can be inserted before or after the scanning of the trajectory when scanning the shorter trajectory. Of course, the scanning speed of the shorter trajectory can alternatively or additionally be set lower than that of the longer trajectory. However, such a procedure is then more complicated, as the change in the scanning speed also changes the amount of energy introduced, which usually has to be compensated for by adjusting the radiation power accordingly.

Preferably, in the case of the presence of a plurality of non-contiguous object cross-sectional regions, each of which covers the boundary, a waiting time is provided in at least one of the two working regions after and/or before a substantially complete scanning of an object cross-sectional region.

An object cross-sectional region here can be a subregion of an object cross-section of an object that is not connected to other subregions of the object cross-section—is not coherent with them. Alternatively, an object cross-sectional region can also correspond to a complete cross-section of an object. The method is used in the latter case in connection with an additive manufacturing device which is adapted to manufacture a plurality of three-dimensional objects with temporal overlap during a manufacturing process. Apart from this, however, if a plurality of objects are present, at least one of the objects can also have an object cross-section which consists of a plurality of non-contiguous object cross-sectional regions.

In the case of object cross-sections whose extent perpendicular to the boundary is different in size in the two working regions, the time required for scanning the trajectories may vary. This can lead to a large time gap in the scanning of locations opposite each other with respect to the boundary in the temporally subsequent scanning of further object cross-sectional regions, even if the subsequent object cross-section regions are symmetrical to the boundary. This can be counteracted by inserting a waiting time before starting to scan the trajectories in the working region with the smaller area portion of the object cross-sectional region when scanning an object cross-sectional region that is located asymmetrical to the boundary. Alternatively or in addition, a waiting time could also be inserted after completion of the scanning of the trajectories in the working region with the smaller area portion. The waiting time is preferably calculated in such a way that the scanning of the trajectories of the timely subsequent object cross-sectional region starts as simultaneously as possible in both working regions, or at least with a short time gap. With this procedure, it can be avoided that a different scanning duration in the two working regions during the solidification of an object cross-sectional region propagates in the solidification of timely subsequent object cross-sectional regions. A small, preferably vanishingly, time difference between the two beams can therefore be achieved at the start of the scanning of timely subsequent object cross-sectional regions.

It should also be noted that in the above procedure, the wording “before the start of scanning of an object cross-sectional region or after the end of scanning of an object cross-sectional region” does not take into account whether a contour of an object cross-sectional region has already been scanned or is still to be scanned. The procedure refers to so-called hatch lines for solidifying the inner regions of an object cross-section.

Preferably, pairs of locations, preferably all pairs of locations, on both sides of the boundary whose distance to each other is less than 1000 times, more preferably less than 500 times, even more preferably less than 100 times, even more preferably less than 50 times, even more preferably less than 10 times, even more preferably less than 5 times, even more preferably less than 3 times the beam width of the first beam on the building material in the first working region, are solidified at a time coordinated with one another.

The beam width can here be considered as the extent of a beam on the build area perpendicular to the direction of movement of the beam. Using the procedure described above, locations on both sides of the boundary that are strongly influenced by temperature changes beyond the boundary can be scanned in a time coordinated manner.

Preferably, the scanning directions of the trajectories in a second layer subsequent to a first layer are rotated by an angle T relative to those of the first layer, wherein the direction of rotation in the first working region is opposite to the direction of rotation in the second working region.

It can be advantageous for the mechanical properties of the object to be manufactured if trajectories in successive layers are not parallel to each other. A procedure is therefore known in the prior art in which the trajectories of one layer are rotated by a certain angle relative to the trajectories in the previous layer.

In the present case, the first layer and the second layer refer to any successive, preferably directly successive, layers. The first layer is therefore not necessarily to be equated with the very bottom layer to be selectively solidified.

In this preferred procedure, unlike the prior art, not all trajectories assigned to a layer or an object cross-section covering the boundary are rotated by the same angle. The symmetrical rotation of the trajectories in the two working regions ensures that the sequence in which the trajectories are scanned, which has already been determined for the first layer, can be adopted in subsequent layers without any changes. The trajectory tracing directions are therefore rotated symmetrically to the boundary. The sequence of directions in which neighboring trajectories are passed (parallel or antiparallel) can also be maintained unchanged.

The method is preferably applied in the solidification of object cross-sections that comprise a downward facing surface region of the object during manufacture, preferably additionally in the solidification of the two object cross-sections directly above such object cross-sections, further preferably additionally in the solidification of four object cross-sections directly above an object cross-section having a surface region facing downward during manufacture.

Especially in regions of an object to be manufactured that face downwards during the manufacture, i.e. in the direction of the building platform or opposite to the direction of the sequence of layers during the manufacturing process, so-called downskin regions, inhomogeneities or temperature cycles during the melting of the building material can lead to irregularities at the downward-facing surface. Such regions do not necessarily only include locations located directly on the downward-facing surface, but sometimes also locations at a certain distance from the surface, as when these locations, which are actually located away from the surface, are melted, effects can still be detected on the downward-facing surface due to heat conduction.

In an additive manufacturing method according to the invention for manufacturing a three-dimensional object, the object is produced by means of an additive manufacturing device by applying a building material layer by layer and solidifying the building material in a build area by means of an energy input device by supplying radiation energy to solidification positions in each layer that are associated with the cross-section of the object in this layer, the energy input device comprises a first beam emitter above the build area from which a first beam is directed to the build area, and a second beam emitter from which a second beam is directed to the build area, the first beam emitter is associated with a first working region in the build area to which the first beam can be directed and the second beam emitter is associated with a second working region in the build area to which the second beam can be directed, wherein the first and second working regions adjoin each other at a boundary, the solidification positions of a layer in the first and second working regions are each scanned by moving the first and second beams, respectively, along a plurality of trajectories in the build area, and the energy input device is controlled by means of a method for controlling an energy input device according to the invention.

In a further additive manufacturing method according to the invention for manufacturing a three-dimensional object, the object is manufactured by means of an additive manufacturing device by applying a building material layer by layer and solidifying the building material in a build area by means of an energy input device by supplying radiation energy to solidification positions in each layer which are associated with the cross-section of the object in this layer, the energy input device comprising a number of beam emitters above the build area from which a number of beams are directed to the build area, the energy input device being controlled by a control data set generated by one of the above methods according to the invention for generating a control data set.

The building material is preferably a material in powder or pasty form. Preferably, it is melted by the supply of radiation energy in order to be present in a solidified state after cooling.

Preferably, polymer-based building material is used in the additive manufacturing methods to which the present application relates.

As already mentioned, polymer-based building material is understood to mean a building material with a polymer content of 55% by volume or more, in particular a polymer powder. Although when polymer-based building material is used, the layer to be solidified is brought to a working temperature before exposure to the beam, which working temperature is only slightly below the temperature present during melting, the inventors were able to determine that the homogeneity of the manufactured objects can nevertheless be improved by the procedure according to the invention.

The polymer-based pasty or pulverulent building material can include, for example, at least one of the polymers selected from the group consisting of the following polymers: Polyetherimides, polycarbonates, polyphenylsulfones, polyphenyloxides, polyethersulfones, acrylonitrile-butadiene-styrene copolymers, polyacrylates, polyesters, polyamides, polyaryletherketones, polyethers, polyurethanes, polyimides, polyamidimides, polyolefins, polystyrenes, polyphenylsulphides, polyvinylidene fluorides, polyamide elastomers such as polyether block amides and copolymers which contain at least two different monomer units of the aforementioned polymers. Suitable polyester polymers or copolymers can be selected from the group consisting of polyalkylene terephtholates (e.g. PET, PBT) and their copolymers. Suitable polyolefin polymers or copolymers can be selected from the group consisting of polyethylene and polypropylene. Suitable polystyrene polymers or copolymers can be selected from the group consisting of syndiotactic and isotactic polystyrenes. The building material in powder form can additionally or alternatively contain at least one polyblend based on at least two of the aforementioned polymers and copolymers. Additives, e.g. anti-caking agents, fillers, pigments, etc. can also be present with the plastic as a matrix.

Preferably, in the additive manufacturing method, layers which are selectively solidified to form an object cross-section having a surface region of the object facing downwards during manufacture, preferably additionally layers which are selectively solidified to form the two object cross-sections directly above such an object cross-section, further preferably additionally layers which are selectively solidified to form the four object cross-sections directly above an object cross-section having a surface region facing downwards during manufacture, are applied with a fraction of the standard layer application thickness, preferably half the standard layer application thickness.

A standard layer application thickness is understood here to be the thickness of the building material with which it is applied as standard during a manufacturing process. The standard layer application thickness is selected so that after solidification of a building material layer of this thickness, a solidified layer is present whose layer thickness corresponds to the thickness of the object cross-sections when a CAD model of the object to be manufactured is partitioned into object cross-sections to which the building material layers are assigned during manufacture. The fraction can be, for example, the value ½, ⅓, ¼, ⅕, ⅙, ⅛, 1/10, ⅔, ¾.

By applying and solidifying the building material with a reduced layer thickness in downskin regions, the homogeneity of the surface facing downwards during manufacture is improved in these regions, as less material has to be melted due to the reduced thickness and the temperature differences are therefore smaller due to the lower amount of energy introduced. In this way, an improved quality of the surfaces facing downwards during manufacture can be ensured in support of the procedure according to the invention when controlling an energy input device, in particular in cases in which the trajectories in the first and second working regions cannot be scanned in an ideal manner according to the invention due to other boundary conditions.

According to the invention, a control device of an energy input device of an additive manufacturing device for manufacturing a three-dimensional object by means of the same,
wherein the additive manufacturing device is adapted to manufacture the object by applying a building material layer by layer and solidifying the building material in a build area by means of the energy input device by supplying radiation energy to solidification positions in each layer associated with the cross-section of the object in this layer,
wherein the energy input device comprises a first beam emitter above the build area from which a first beam is directed to the build area, and a second beam emitter from which a second beam is directed to the build area,
wherein the first beam emitter is assigned a first working region in the build area to which the first beam can be directed, and the second beam emitter is assigned a second working region in the build area to which the second beam can be directed,
wherein the first and second working regions adjoin each other at a boundary,
comprises a scanning control unit that is configured to cause the energy input device to scan the solidification positions in the first and second working regions by moving the first and second beams, respectively, along a plurality of trajectories in the build area,
wherein the scanning control unit coordinates the movements of the first and second beams so that locations to be solidified in the first working region are scanned at a time coordinated with locations to be solidified in the second working region.

The control device of an energy input device is capable of implementing the method described above for controlling an energy input device, in which the direction of the movement vectors along the trajectories is defined. The individual components of the device, i.e. in particular the scanning control unit, or the entire control device can be implemented by software alone or by hardware alone or by means of a mixture of hardware and software. Interfaces do not necessarily have to be designed as hardware components but can also be implemented as software modules. Interfaces can also consist of both hardware and software components, for example in the form of a standard hardware interface that is specially configured by software for the specific application. In addition, several interfaces can also be combined in a common interface, for example an input/output interface.

In particular, the control device can be a unit within a controlling device that controls a manufacturing process in an additive manufacturing device. Nevertheless, it should be emphasized that the control device can also be present outside the controlling device in the same way and can exchange signals with the additive manufacturing device, in particular with the energy input device, via a network. In particular, if the control device is implemented solely by means of software, the control device can be in the form of a computer program. Preferably, such a computer program for a manufacturing process is then executed by the additive manufacturing device in its controlling device.

An additive manufacturing device according to the invention for manufacturing a three-dimensional object, the object being manufactured by means of the additive manufacturing device by applying a building material layer by layer and solidifying the building material in a build area by means of an energy input device by supplying radiation energy to solidification positions in each layer associated with the cross-section of the object in this layer, the additive manufacturing device comprising:
a layer application device suitable for applying a layer of a building material to an already existing, preferably already selectively solidified, building material layer, and
an energy input device suitable for supplying radiation energy to solidification positions in each layer associated with the cross-section of the object in this layer, the energy input device comprising, above the build area, a first beam emitter from which a first beam can be directed to the build area and a second beam emitter from which a second beam can be directed to the build area,
wherein the first beam emitter is assigned a first working region in the build area to which the first beam can be directed, and the second beam emitter is assigned a second working region in the build area to which the second beam can be directed,
wherein the first and second working regions adjoin each other at a boundary,
wherein the solidification positions of a layer in the first and second working regions are each scanned by moving the first and second beams, respectively, along a plurality of trajectories in the build area,
wherein the additive manufacturing device according to the invention comprises a control device of an energy input device according to the invention and/or is connected in terms of signalling to a control device of an energy input device according to the invention.

As already mentioned above, in practice the working regions can be defined by the control software of the beam emitters. In other words, apart from such a definition by software, two beam emitters can be able to reach individual subregions of the build area or even the entire build area together.

The present invention is not limited to additive manufacturing devices in which only two beam emitters are present. It can also be applied in connection with manufacturing devices in which more than two beam emitters are present. In the latter case, the method according to the invention is then used for two beam emitters whose working regions adjoin each other.

Further features and expediencies of the invention arise from the description of exemplary embodiments with reference to the attached figures.

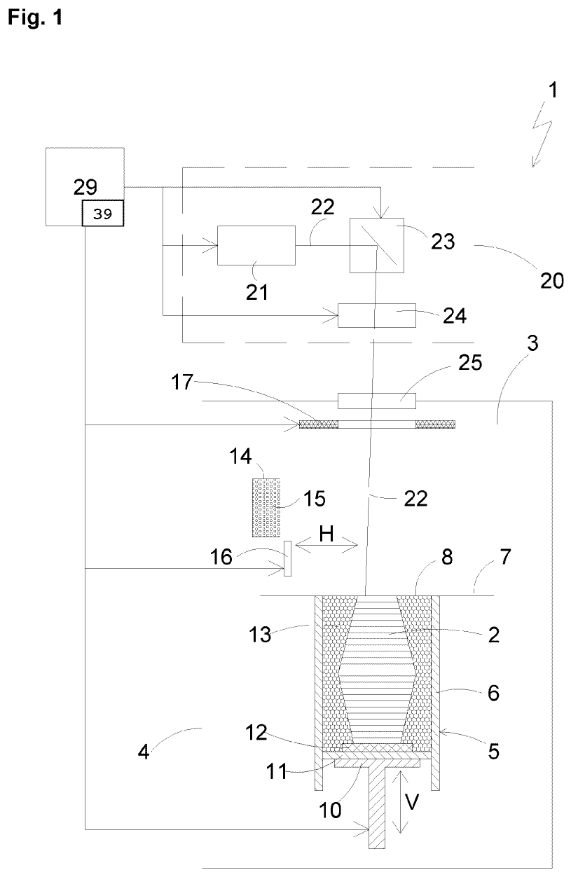

FIG. 1 shows a schematic view, partially in cross-section, of an exemplary device for additive manufacturing of a three-dimensional object according to the invention.

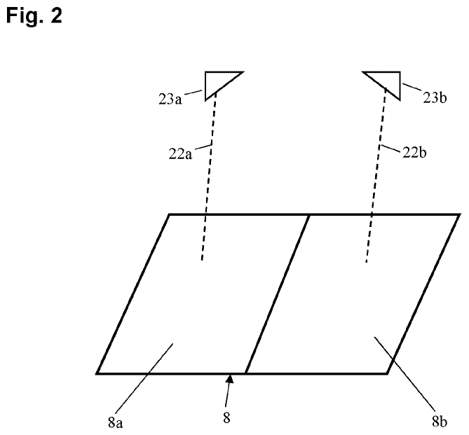

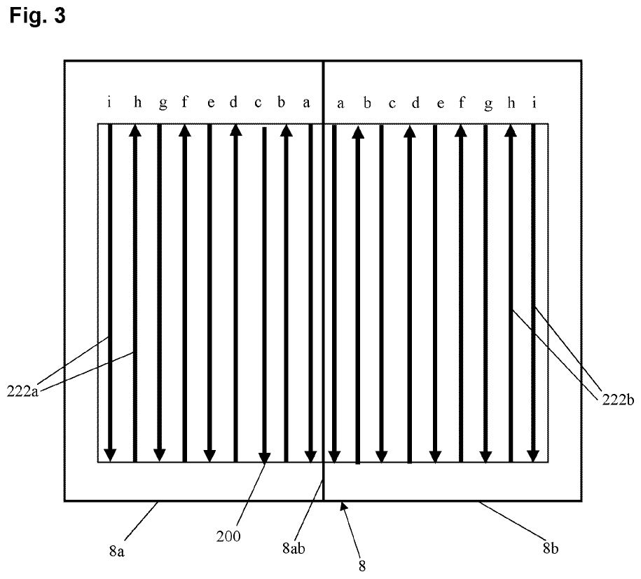

FIG. 2 shows a schematic view of the build area in an oblique manner from above.

FIG. 3 shows a schematic view of the build area from above and looking perpendicular to the build plane to illustrate a first exemplary embodiment of a procedure according to the invention.

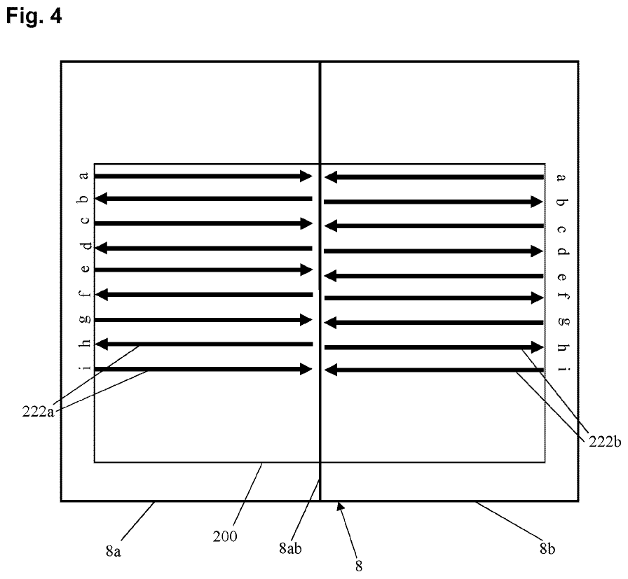

FIG. 4 shows a first variant of a second exemplary embodiment of a procedure according to the invention.

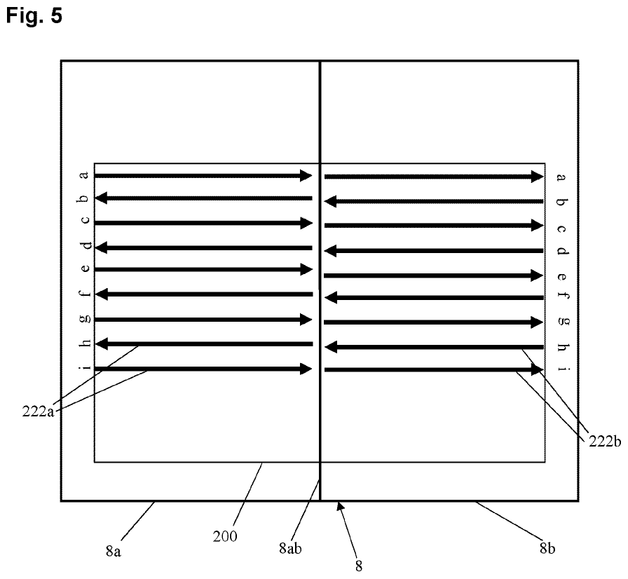

FIG. 5 shows a second variant of a second exemplary embodiment of a procedure according to the invention.

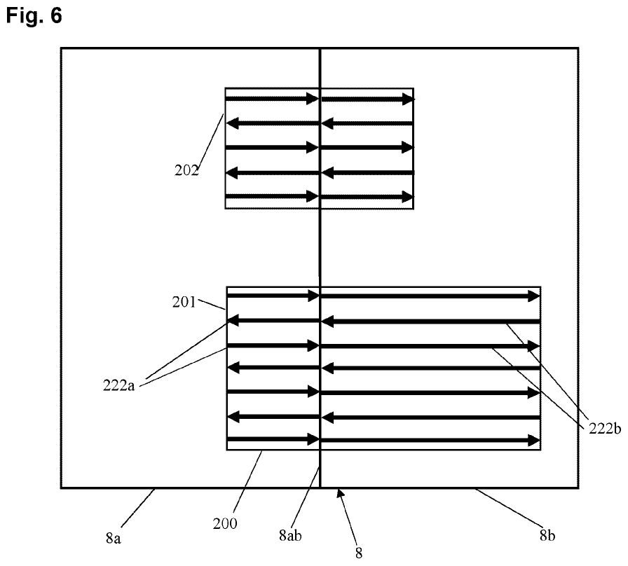

FIG. 6 illustrates a variant of the procedure in the case of the presence of several object cross-sections to be solidified in one layer.

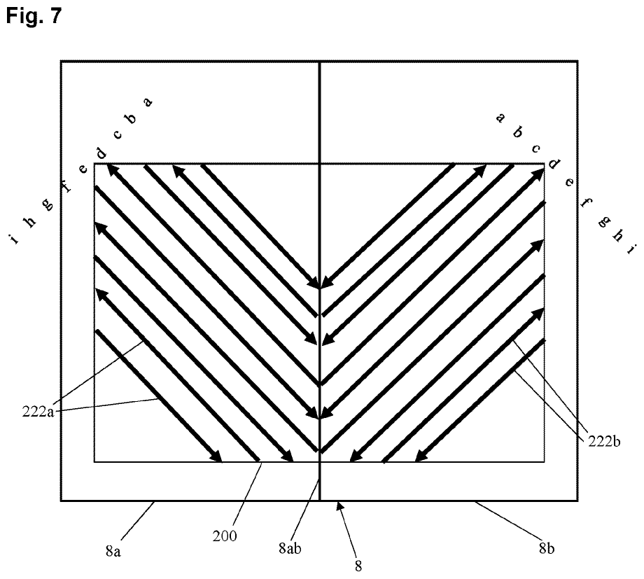

FIG. 7 illustrates a procedure for trajectories that extend oblique to the boundary.

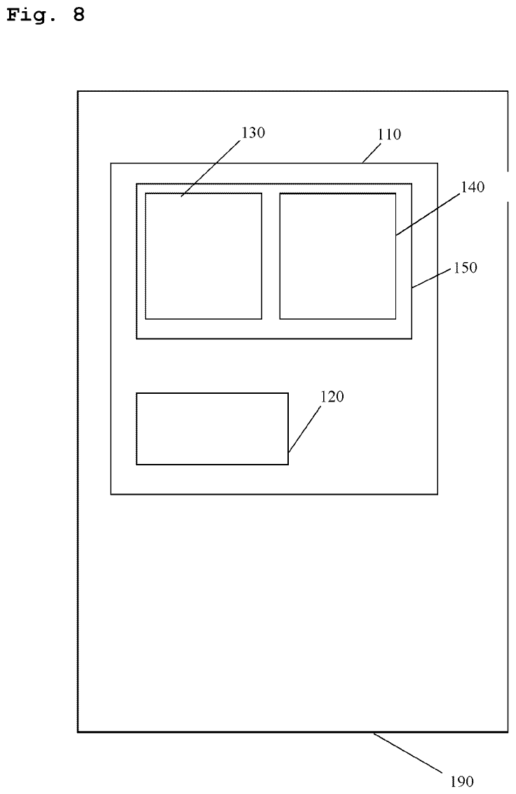

FIG. 8 schematically shows an exemplary embodiment of a control device for an energy input device.

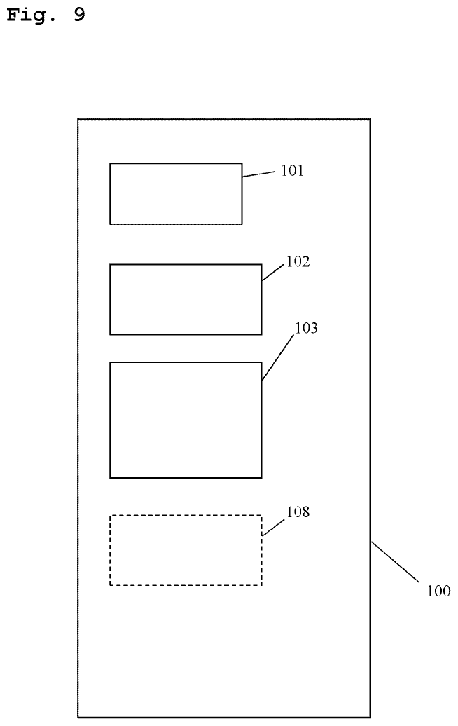

FIG. 9 shows the schematic structure of a device for providing control data.

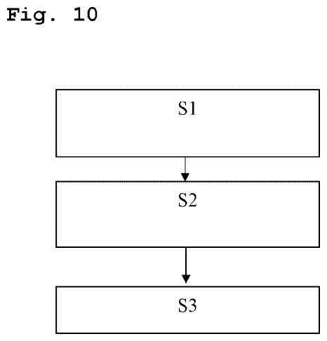

FIG. 10 illustrates the sequence of a method for providing control data.

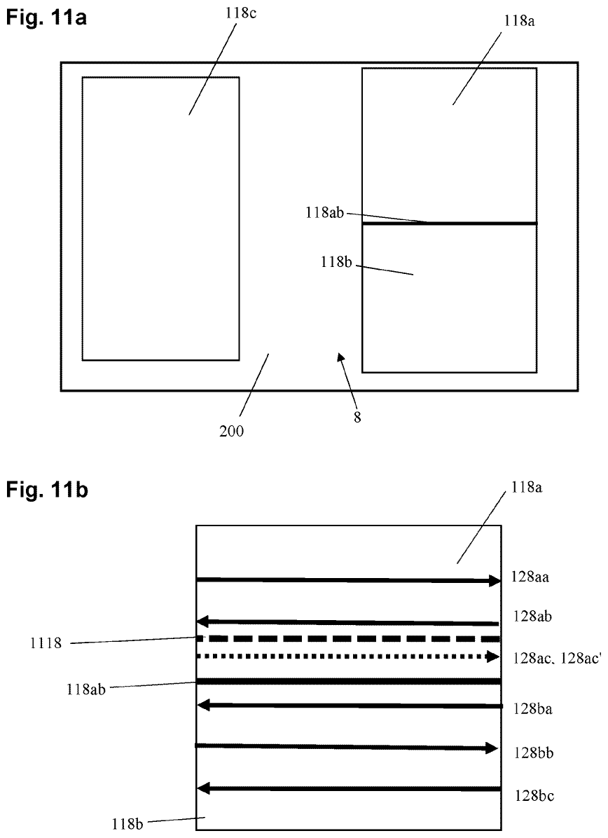

FIGS. 11a and 11b schematically illustrate a third exemplary embodiment of the invention.

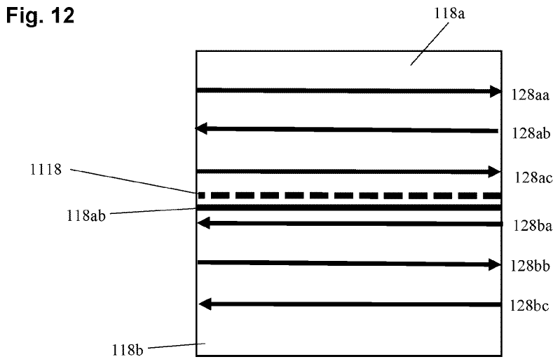

FIG. 12 shows a variant of the procedure illustrated in FIG. 11b.

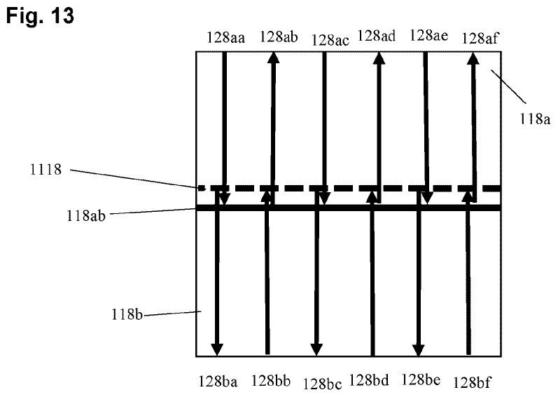

FIG. 13 shows another variant of the procedure illustrated in FIG. 11b.

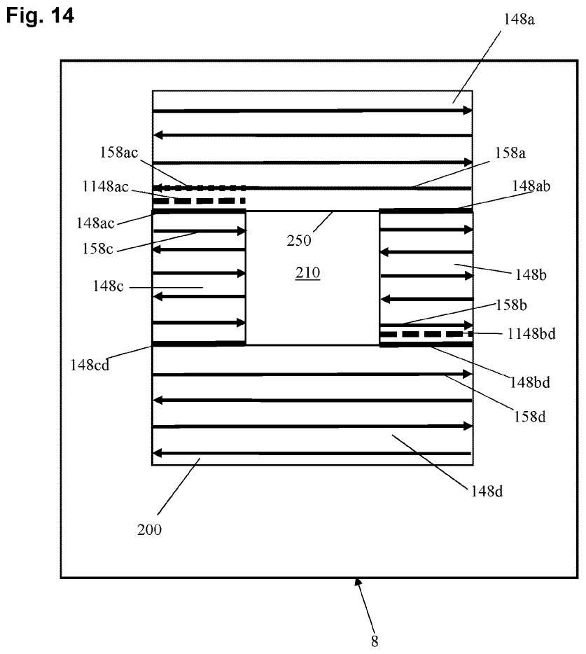

FIG. 14 schematically illustrates a fourth exemplary embodiment of the invention.

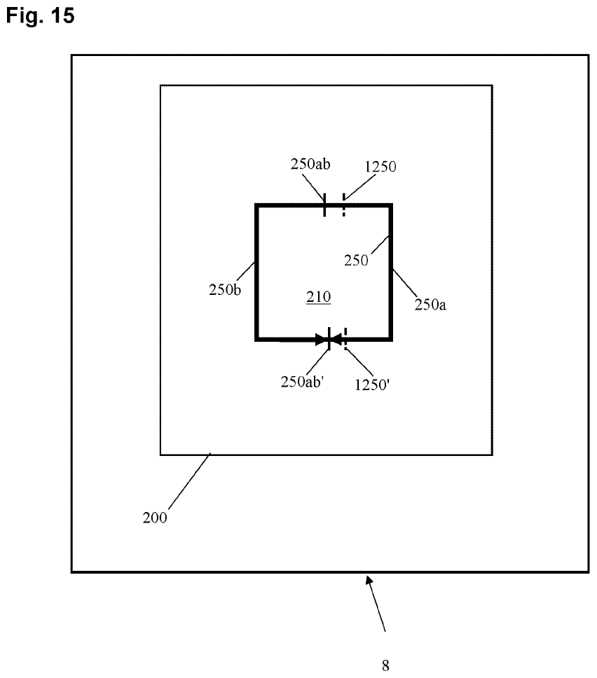

FIG. 15 schematically illustrates a fifth exemplary embodiment of the invention.

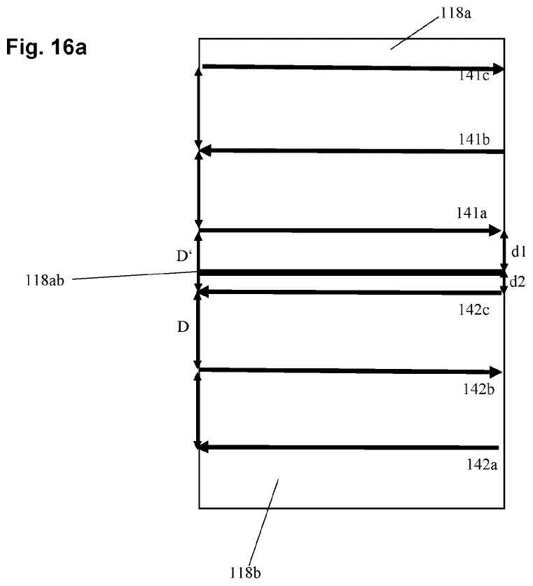

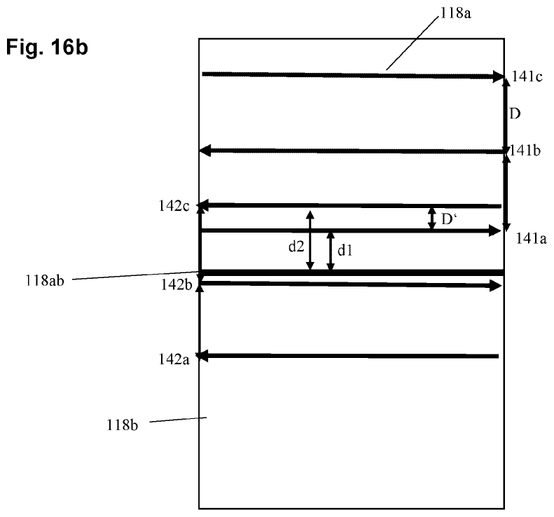

FIGS. 16a and 16b schematically illustrate a further procedure according to the invention.

For a description of the invention, an additive manufacturing device according to the invention will first be described below with reference to FIG. 1, using a laser sintering or laser melting device as an example.

In order to build an object 2, the laser sintering or laser melting device 1 contains a process chamber or build chamber 3 with a chamber wall 4. A building container 5 open to the top and having a container wall 6 is arranged in the process chamber 3. A working plane 7 (also referred to as build plane) is defined by the upper opening of the building container 5, wherein the region of the working plane 7 located within the opening, which can be used for building the object 2, is referred to as build area 8.

A support 10, which can be moved in a vertical direction V, is arranged in the building container 5, to which support a base plate 11 is attached that closes the container 5 to the bottom and thus forms the bottom thereof. The base plate 11 can be a plate formed separately from the support 10, which is attached to the support 10, or it can be formed integrally with the support 10. Depending on the powder and process used, a building platform 12 can also be attached to the base plate 11 as a building base on which the object 2 is built. However, the object 2 can also be built on the base plate 11 itself, which then serves as a building base. In FIG. 1, the object 2 to be formed in the container 5 on the building platform 12 is shown below the working plane 7 in an intermediate state with several solidified layers surrounded by building material 13 that has remained unsolidified.

The laser sintering or laser melting device 1 also contains a storage container 14 for a building material 15, in this example a powder that can be solidified by electromagnetic radiation, and a recoater 16 that can be moved in a horizontal direction H for applying the building material 15 within the build area 8. Optionally, a heating device, e.g. a radiant heater 17, can be arranged in the process chamber 3, which serves to heat the applied building material. The radiant heater 17 can be an infrared heater, for example.

The exemplary additive manufacturing device 1 further comprises an energy input device 20 having a laser 21 (e.g. a CO2 laser or a CO laser), which generates a laser beam 22 that is deflected via a beam emitter 23, for example one or more galvanometer mirrors together with the associated drive, and is focused onto the working plane 7 by a focusing device 24 via a coupling window 25, which is attached to the top of the process chamber 3 in the chamber wall 4. Although not shown in FIG. 1, some embodiments of the additive manufacturing device according to the invention comprise at least two and preferably exactly two beam emitters 23. This allows a manufacturing process to take place in a shorter time, as the building material can then be scanned and solidified at different locations simultaneously with several beam bundles.

The specific structure of a laser sintering or laser melting device shown in FIG. 1 is only exemplary for the present invention and can, of course, also be modified, in particular when using an energy input device other than that shown. In order to make it clear that the area of the beam impingement region on the building material does not necessarily have to be very small (“point-shaped”), the term “beam” is often used in this application instead of “ray”.

The laser sintering device 1 further contains a controlling device 29, via which the individual components of the device 1 are controlled in a coordinated manner to carry out the building process. Alternatively, the controlling device can be partially or completely external to the additive manufacturing device. The controlling device can include a CPU whose operation is controlled by a computer program (software). The computer program can be stored separately from the additive manufacturing device in a storage device, from where it can be loaded (e.g. via a network) into the additive manufacturing device, in particular into the controlling device.

During operation, the controlling device 29 lowers the support 10 layer by layer, controls the recoater 16 to apply a new powder layer and controls the energy input device 20, i.e. in particular the beam emitters 23 and possibly also the laser 21 and/or the focusing device 24, to solidify the respective layer at the locations corresponding to the respective object by scanning these locations with the laser. In doing so, in the present application, reference is made to a unit 39 within the controlling device 29, which unit is responsible for controlling the energy input device 20 as the control device 39 of the energy input device. Nevertheless, it should be emphasized that a control device of the energy input device can also be present outside the controlling device 29 in the same way (also in the form of a computer program), provided that it is ensured that the control device 39 of the energy input device can cooperate sufficiently with the controlling device 29 for the additive manufacturing of objects, i.e. in particular can exchange signals.

FIG. 2 schematically shows an oblique view of the build area 8 from above, in which a first beam emitter 23a is assigned a first working region 8a in the build area 8 and a second beam emitter 23b is assigned a second working region 8b in the build area 8. In other words, the working region 8a defines the locations in the build area 8 to which a first beam 22a can be directed by the first beam emitter 23a and the working region 8b defines the locations in the build area 8 to which a second beam 22b can be directed by the second beam emitter 23b. As shown in FIG. 2, the first working region 8a and the second working region 8b together preferably cover the entire build area 8. Furthermore, the first working region 8a and the second working region 8b do not necessarily have to be directly adjacent to each other. Rather, they can also overlap in a corridor on both sides of the boundary (overlap width or corridor width e.g. greater than or equal to 0 mm and/or less than or equal to 1 mm) or there can be a narrow gap (e.g. with a width greater than or equal to 50 μm and/or less than or equal to 500 μm) between the working regions at the boundary.

FIG. 3 shows another schematic view of the build area 8 from above, in this case the viewing direction is perpendicular to the build plane 7. Again, the two working regions 8a and 8b are shown, and a cross-section 200 of the object to be solidified is also shown as an example, which has a rectangular shape for the sake of simplicity. Here, the vertical arrows represent trajectories 222a, 222b along which the respective beam (e.g. a laser beam) is moved across the cross-section 200 in each of the working regions 8a and 8b. For the sake of clarity, only the two outermost trajectories are provided with a reference sign. As can be seen, all trajectories extend parallel to each other in a vertical direction (with regard to the plane of the drawing). In this case, a parallel or substantially parallel alignment of the trajectories, which is common in the prior art, is chosen to solidify an area, which is also referred to as “hatching” in technical jargon. Preferably, neighboring trajectories are passed through in opposite directions, although it is possible in principle (and also in the present invention) for all trajectories to be passed through in the same direction.

In order to prevent the building material from being melted several times or from cooling down again between successive melting processes during solidification of the building material near or at the boundary 8ab between the two working regions, which leads to shrinkage effects or inhomogeneities at the boundary, the scanning in the two working regions 8a and 8b is carried out according to the invention in a coordinated, i.e. at a time coordinated, manner. FIG. 3 here shows a first exemplary embodiment of such a coordinated procedure, in which the hatch lines (trajectories) extend substantially parallel to the boundary 8ab. Here, lower-case letters a to i are placed above the individual hatch lines, which are intended to indicate the time sequence in which the trajectories are passed through by means of their alphabetical order. This defines a trajectory tracing direction in the left working region that points to the left and a trajectory tracing direction in the right working region that points to the right.

In the example of FIG. 3, the scanning in the two working regions 8a and 8b starts with the trajectories 222a and 222b closest to the boundary 8ab respectively, wherein the trajectory tracing directions are symmetrical to the boundary. In order to enable homogeneous melting of the building material across the boundary, the start of scanning in both working regions should take place at the same time or with a small time difference (preferably with a time difference of less than 200 ms). FIG. 3 shows the ideal case here, in which the direction of movement along the two trajectories closest to the boundary 8ab (each labelled “a”) is the same on both sides of the boundary. However, it is of course also possible for the trajectories closest to boundary 8ab to be scanned in different directions. It is also possible to proceed in the manner described if, in each of the two working regions, neighboring trajectories are not scanned in opposite directions (as shown in FIG. 3), but all trajectories are scanned in the same direction.

While FIG. 3 shows the case in which the trajectories labelled “a” near the boundary 8ab are scanned first, the trajectory tracing directions can also be reversed, provided that the trajectory tracing directions are still symmetrical to the boundary. In particular, the scanning could also start in both working regions with the trajectories i, so that the trajectories a would then be scanned last.

FIG. 4 shows a first variant of a second exemplary embodiment of a procedure according to the invention. The figure is similar to FIG. 3 and the same features are designated with the same reference signs. The difference to the first exemplary embodiment is that the trajectories in FIG. 4 extend substantially perpendicular to the boundary 8ab between the two working regions 8a and 8b. As in FIG. 3, not all trajectories are shown, but only a number of trajectories that are passed through first when the object cross-section 200 is scanned in the respective working region. As in FIG. 3, in FIG. 4 the trajectory tracing directions in the two working regions are symmetrical to the boundary 8ab, too. Here again, the trajectory tracing directions result from the alphabetical order of the letters, which characterizes the temporal order of the scanning of the trajectories. As can be seen, in FIG. 4 the trajectory tracing direction points downwards in both working regions.

While in FIG. 4 the trajectories and their scanning directions are symmetrical to the boundary 8ab, i.e. the locations of two trajectories, which two locations are scanned last or first, are located on opposite sides of the boundary, the scanning direction of one working region can also continue in the other working region, as shown in a second variant of the second exemplary embodiment in FIG. 5. The trajectory tracing direction can also be reversed in both working regions, i.e. extended from bottom to top, in contrast to FIGS. 4 and 5. In any case, it is important that the trajectory tracing directions extend symmetrically to the boundary. The procedure illustrated in FIG. 4 leads to a particularly good homogeneity of the objects, as locations close to the boundary are scanned within a narrow time frame. Thus, the trajectories that are passed through first (labelled “a”) meet at the boundary 8ab, so that the two beams 22a and 22b arrive at the boundary 8ab at substantially the same time. When the next trajectories (labelled “b”) are passed through, the two beams 22a and 22b start at the boundary 8ab at substantially the same time, and so on.

Even if neighboring trajectories are not passed through in opposite directions, according to the invention the trajectory tracing direction and preferably also the direction of movement of the beam 22a in the first working region 8a should be symmetrical to the trajectory tracing direction and to the direction of movement of the beam 22b in the second working region 8b. In other words, preferably, the beams should then move towards or away from each other with respect to the boundary 8ab.

The described procedures according to the first and second exemplary embodiments can be implemented particularly well if an object cross-section is substantially symmetrical to the boundary 8ab between the two working regions, as the trajectories on both sides of the boundary then have substantially the same length. Also, a high scanning speed (speed of movement of the impact region of the beam on the build area) ensures that unequal areas of the object cross-section in both working regions do not have too disadvantageous an effect in the procedure according to the invention. Nevertheless, if the position of an object cross-section is very asymmetrical with respect to the boundary, additional measures can be taken to ensure improved coordination during scanning in the two working regions 8a and 8b.

If, for example, as shown in the object cross-section 201 at the bottom of FIG. 6, the trajectories 222a in the working region 8a are shorter than the trajectories 222b in the working region 8b, then a waiting time can be inserted in the working region 8a having the shorter trajectories after each trajectory has been passed through until the correlated longer trajectory in the other working region 8b has also been passed through completely. The beginning of scanning the respective next trajectory is then at substantially the same time in both working regions. The insertion of a waiting time can be implemented in such a way that the laser beam supplied to the associated beam emitter is switched off, blocked or deflected during the waiting time so that it no longer reaches the build area. Alternatively, the radiation power impinging on the building material via the beam can be reduced so much during the waiting time that the amount of energy impinging on the building material during the waiting time is not sufficient to melt the building material.

It is understood that the procedure just described is not limited to the example of the object cross-section 201 in FIG. 6. A large number of other situations are possible. For example, a waiting time does not necessarily always have to be inserted after scanning a shorter trajectory. It is also conceivable to insert a waiting time only after every second, third, etc. shorter trajectory. The number of shorter trajectories that are scanned between two waiting times can also vary.

Furthermore, there are of course also situations in which, within an object cross-section, the shorter trajectories are sometimes in one working region 8a and sometimes in the other working region 8b. In these situations, the same procedure can be used to scan the shorter trajectories. Also, with regard to the insertion of waiting times, the trajectories do not necessarily have to be located perpendicular to the boundary 8ab. In particular, waiting times can also be inserted when scanning according to the first exemplary embodiment of FIG. 3 (with the scanning direction substantially parallel to the boundary) in order to provide compensation for very unequal sizes of the cross-sectional regions to be solidified on both sides of the boundary.

In particular, the wait time does not necessarily have to be inserted after the shorter trajectory has been passed through, but can also be inserted before the start of the scanning of the shorter trajectory or at any time during the scanning of the shorter trajectory. It is also conceivable to insert several waiting times instead of a single waiting time.

Alternatively or in addition, the speed of movement of the beam along the shorter trajectory can be reduced and/or the speed of movement along the longer trajectory can be increased in order to thus achieve that locations of the object cross-section on both sides of the boundary 8ab are scanned by the first and second beams at a short time interval from each other. When the speed of movement of the beam is changed, the radiation power must usually also be adjusted at the same time so that the desired amount of energy is introduced into the building material in the build plane for a homogeneous melting process.

Of course, the insertion of individual waiting times for the individual trajectories, in particular between the scanning of neighboring trajectories, is associated with increased coordination effort, which makes the control of the beam emitters more complicated. It is therefore preferable to insert a waiting time in the working region in which the smaller area portion of the object cross-section is located before starting to scan the object cross-sectional region in this working region. Here, the length of the waiting time can be selected so that the scanning of the object cross-section in the first and second working regions ends at substantially the same time. For example, in the first exemplary embodiment in the case deviating from FIG. 3, in which the trajectory tracing direction points from left to right in the working region 8a and the trajectory tracing direction points from right to left in the working region 8b, it is advisable to insert a waiting time in the working region 8a before the start of scanning if the object cross-sectional region to be solidified is smaller in working region 8a than in working region 8b. In this case, the trajectories closest to the boundary 8ab are then scanned with a small time difference.

Alternatively, a waiting time before and/or after the scanning of the smaller object cross-sectional portion can be selected so that half of the area of the object cross-section located in the respective working region is scanned in both working regions at the same time. Of course, other settings for the waiting time are also possible, as long as the portion of the object cross-section in the working region with the smaller area to be scanned is completely scanned during the scanning of the object cross-section in the other working region. For example, a waiting time could also be inserted in the working region in which the smaller area portion of the object cross-section is located, after the end of the scanning of the object cross-sectional region in this working region, especially in the case in which the scanning starts at the same time in both working regions.

In particular, if there are a plurality of object cross-sectional regions in a layer that cover the boundary 8ab, i.e. cross-sectional regions that are assigned to different objects or unconnected cross-sectional regions of one and the same object, the insertion of waiting times can ensure better coordination during scanning. This is explained below with reference to FIG. 6.

FIG. 6 shows two object cross-sections 201 and 202 that are to be solidified, wherein it is assumed as an example that in the course of scanning the trajectories 222a and 222b in the working regions 8a and 8b, the trajectories in the object cross-section 201 are scanned first before the trajectories in the object cross-section 202. Since the object cross-section 201 is asymmetrical to the boundary 8ab, without further measures the beam 22a in the working region 8a would finish scanning the object cross-section 201 at an earlier point in time than the beam 22b in the working region 8b. As a result, the beam 22a would start scanning the object cross-section 202 at an earlier point in time than the beam 22b, so that significant time differences in the scanning of the trajectories near the boundary would have to be expected in the object cross-section 202. Here, the insertion of a waiting time before the start of the scanning of the object cross-section 201 in the working region 8a or after the end of the scanning of the object cross-section 201 in the working region 8a offers the possibility of ensuring that both beams 22a and 22b start scanning the object cross-section 202 at substantially the same time or with a small time gap. Again, the trajectories do not necessarily have to be perpendicular to the boundary 8ab. In particular, the procedure is also possible for scanning according to the first exemplary embodiment of FIG. 3 (with the scanning direction substantially parallel to the boundary).

The following describes a procedure variant that can be used in connection with all embodiments.

In the additive manufacturing of objects (e.g. by means of laser sintering or laser melting), the orientation of the trajectories from layer to layer is often changed by a certain angle (e.g.) 90° in order to reduce shrinkage effects and residual stresses. Such a procedure is also possible in connection with the present invention. For this purpose, the trajectories and their scanning directions in the two working regions are preferably rotated by the same angle, but in opposite rotation directions. For example, a rotation clockwise by the corresponding angle is implemented in the first working region and a rotation counterclockwise by the corresponding angle is implemented in the second working region. In other words, the direction of rotation must be symmetrical in relation to the boundary 8ab. The point of such a procedure is that, despite the change in orientation of the trajectories in both working regions, the trajectory tracing directions in both working regions are still symmetrical to the boundary.

Assuming, for example, that in one layer the building material is scanned according to the first exemplary embodiment shown in FIG. 3, then in the following layer, with a rotation angle of 90° from layer to layer, the scanning would be carried out according to the first variant of the second embodiment shown in FIG. 4. As can be seen, in FIG. 4 the scanning directions of the trajectories in the first working region 8a are rotated counterclockwise by an angle of 90° with respect to those in FIG. 3, and the scanning directions of the trajectories in the second working region 8b are rotated clockwise by an angle of 90° with respect to those in FIG. 3.

Even if the angle of rotation differs from 90° from layer to layer, it is still possible to proceed in the manner described. This is illustrated with the aid of FIG. 7. It shows a case in which the scanning directions of the trajectories in the first working region 8a are rotated counterclockwise by an angle of 45° compared to those in FIG. 3 and the scanning directions of the trajectories in the second working region 8b are rotated clockwise by an angle of 45° compared to those in FIG. 3. In this case, too, a symmetrical position of the trajectory tracing directions and correspondingly a symmetrical passing through of the trajectories can ensure that locations near the boundary 8ab in the two working regions are scanned with the beam at the same time or with a small time interval between them.

A possible implementation of a control device of an energy input device, which allows the above-mentioned procedures, is described below with reference to FIG. 8:

As shown in FIG. 8, the control device 190 comprises a scanning control unit 110. The scanning control unit has access to a memory 150 in which a control data set 130 is stored, which specifies the locations of a layer at which solidification of the building material is to be effected by the supply of radiation. Furthermore, the scanning control unit 110 has access to a second data set 140 in the memory 150 in which the working regions of the two beam emitters (scanners) are specified, i.e. an assignment of locations of the build area to the scanners is present. A scan control module 120 in the scanning control unit 110 controls each of the two scanners in such a way that the locations that are to be solidified and are specified in the control data set 130, which locations are located in the working region of the respective scanner, are scanned by this scanner. In doing so, scanning is performed along trajectories parallel to each other (hatch lines) whose length and orientation in the build plane are specified by the scanning control unit 110. Here, the scanning control unit 110 ensures that the sequence of scanning of the scan lines in the first and second working regions is coordinated in such a way that locations to be solidified in the first working region 8a are scanned at a time coordinated with locations to be solidified in the second working region 8b. How to proceed here can be specified by the control data set 130, which was configured accordingly before the start of the manufacturing process.

In the exemplary embodiments of the invention described so far, the scanning of the trajectories in both working regions to solidify an object cross-section is achieved by ensuring substantially symmetrical trajectory tracing directions in both working regions. A further improvement in the homogeneity of the manufactured object at the boundary can be achieved by placing the trajectories on both sides of the boundary in mirror image to each other and then, in a further improvement stage, also scanning them in symmetrical directions with respect to the boundary. If the area proportions of an object cross-section are different in the two working regions, a waiting time can also be inserted in the working region with the smaller area proportion in order to improve the homogeneity. This is also relatively easy to implement. However, if particularly high demands are placed on the homogeneity of the objects produced, an even more precise but also more complex procedure can be used, which is described below.

The extent to which a scanning of a location in a working region leads to a relevant temperature increase of locations in the other working region depends on the distance to the locations in the other working region and the time offset to the scanning of the locations in the other working region. Therefore, when generating the control data set for locations close to the boundary in one working region, ideally for all locations in the working region to be scanned, it is possible to check whether a predetermined maximum time interval is maintained to the time of scanning of locations close to the boundary in the other working region, ideally to the time of scanning of all locations in the other working region, for a preliminarily defined scanning sequence of the locations to be scanned in this working region. If this is not the case, the scanning strategy can be changed, e.g. by inserting waiting times and/or by changing the orientation of the trajectories and, if necessary, changing the orientation of the scanning directions. Experience has shown that a maximum time interval of 200 ms should be maintained for normal requirements on the homogeneity of the objects with polymer-based building materials, which can also assume a lower value, e.g. 100 ms, 50 ms, 20 ms or 10 ms, for increased requirements on homogeneity.

The greater the distance between two locations to be solidified, the lower the mutual influence if thermal energy is supplied to one of the locations during scanning. For reasons of efficiency, it is therefore advisable to carry out the above-mentioned test only for locations to be solidified in both working regions whose mutual distance is less than a predefined minimum distance. This minimum distance depends on the thermal conductivity properties of the building material used and on the process conditions provided by the type of building material. For example, when polymer-based building material is used, only a small proportion of the energy required for a melting process is introduced into the building material by the beam, e.g. a laser beam. The latter is usually preheated to a working temperature just below the melting temperature using a heating device. The case is different with metal-containing building material. Here, the working temperature is well below the melting point and a relatively high amount of energy is introduced into the building material during scanning.

Experience has shown that if the requirements for homogeneity of the objects are not too high for polymer-based building materials, it should be sufficient to carry out the test for locations where the distance between them is less than 3 times the beam width of the beam. With increasing requirements for homogeneity, it may be necessary to consider locations where the mutual distance is less than 5 times, 10 times, 50 times, 100 times, 500 times or even 1000 times the beam width of the beam.

A control data set that enables a control device of an energy input device of an additive manufacturing device the control according to the invention can be generated in the following way:

A device 100 for generating a control data set, which is shown schematically in FIG. 9 and generally implemented by means of software, contains a data access unit 101 which accesses a data set with a data model (e.g. a CAD model) of a number of cross-sections of the object. In the process sequence shown in FIG. 10, this is the first step S1. Ideally, a so-called “slicing” has already been carried out, i.e. an assignment of the object cross-sections to building material layers.

In the second step S2 shown in FIG. 10, a data model generation unit 102 shown in FIG. 9 now specifies in the data model of at least one object cross-section a solidification of locations of a building material layer in a temporal sequence that corresponds to the movement of the first and second beams along a plurality of trajectories across the building material in the first and second working regions. In doing so, in particular, a timing of locations to be solidified in the first working region 8a to locations to be solidified in the second working region 8b is specified. In a variant of the device for generating a control data set, which is used in the case of high requirements for the homogeneity of the manufactured objects, a test unit 108 is also present (shown as a dashed line), which checks whether a predetermined maximum time interval is maintained at the time of the scanning of locations close to the boundary in the other working region, ideally at the time of the scanning of all locations in the other working region, for a preliminarily defined scanning sequence of the locations to be scanned in one working region. If this is not the case, the data model generation unit 102 is prompted to modify the data model.

After a data model has been generated in the second step S2 in FIG. 10, a control data set is then generated by the control data generation unit 103 shown in FIG. 9 (in FIG. 10, this is step S3). Either the data model generated in the second step S2 can be provided as control information (control data), or the data model is reformatted for better integration into a control data set. The procedure described can be used for all object cross-sections of an object to be manufactured.

The procedure according to the invention is particularly advantageous in so-called downskin regions. These are regions in the object to be manufactured that are adjacent to unsolidified powder underneath the object during manufacture. The inventors have found that the surfaces facing downwards during production, i.e. towards the building platform, can have defects at the boundary between the two working regions.

The coordination in time of the scanning of locations in the two working regions according to the invention should be used in particular for object cross-sections which are directly adjacent to unsolidified building material below, i.e. contain surface regions of the object which face downwards during manufacture. Preferably, the coordination in time according to the invention should be used for the lowest three object cross-sections above unsolidified building material, and further preferably for the lowest five object cross-sections.

Auxiliary, for a high quality of the surface regions of the object that face downwards during manufacture, a layer of unsolidified building material can be applied not with the same thickness as in other object regions (the standard layer application thickness), but with a fraction of this thickness, e.g. 50% of this thickness, for the manufacture of the lowest three object cross-sections, preferably for the manufacture of the lowest five object cross-sections.

FIG. 11a shows a schematic view of the build area 8 vertically from above to illustrate a third exemplary embodiment. Here, three subregions 118a, 118b and 118c to be solidified can be seen, of which the subregions 118a and 118b to be solidified adjoin each other at a boundary 118ab. The subregions to be solidified are regions to be solidified in the building material layer, which could basically be solidified with different laser beams, but in this exemplary embodiment are solidified one after the other with one and the same laser beam.

It is assumed here that the subregion 118a to be solidified is scanned first, then the subregion 118c to be solidified and finally the subregion 118b to be solidified. As a result, there is an interruption period Δt between the end of the scanning of the subregion 118a to be solidified and the start of the scanning of the subregion 118b to be solidified. During this period, the building material in the already scanned subregion 118a to be solidified can cool down, which can result in a loss of material (an inhomogeneity in the solidified material) at the boundary 118ab. In order to prevent this inhomogeneity in the solidified material, the procedure illustrated in FIG. 11b is carried out.

FIG. 11b shows an enlarged view of the two sections of the subregions 118a and 118b to be solidified adjacent to the boundary 118ab. Here, trajectories 128aa, 128ab and 128ac are also shown, along which the building material in the subregion 118a to be solidified was scanned, wherein first the trajectory 128aa, then the trajectory 128ab and finally the trajectory 128ac was scanned. Similarly, trajectories 128ba, 128bb and 128bc are shown in the subregion 118b to be solidified, along which the building material is scanned in the subregion 118b to be solidified, wherein first the trajectory 128ba is scanned, then the trajectory 128bb and finally the trajectory 128bc.

In order to ensure better homogeneity in the solidified material at the boundary 118ab, the building material in a section of the subregion 118a to be solidified is scanned again at the boundary after the interruption period Δt has elapsed, before scanning of the subregion 118b to be solidified is started. In FIG. 11b, the line 1118 indicates a limit of this section, which thus extends between the boundary 118ab and the line 1118. By scanning the building material again in this section, it can be melted again or at least heated to such an extent that the material shrinkage at the boundary can be counteracted. Of course, the building material in the subregion 118a to be solidified can also be scanned again at a greater distance from the boundary 118ab than that marked by the line 1118. However, the line 1118 delimits a section in which all locations should be scanned again and can therefore be regarded as the minimum distance.

In the specific case of FIG. 11b, the beam is simply moved again along the trajectory 128ac to scan again all locations within the section delimited by the boundary 118ab and the line 1118. To make it clear that a second trajectory 128ac′ is located on top the trajectory 128ac, the trajectory 128ac is shown as a dashed line in FIG. 11b. Taking into account that when moving the beam along the trajectory 128ac′, the region actually melted is not line-shaped, but also extends to the left and right of the trajectory (among other things due to the non-zero width of the beam), then by moving the beam along the trajectory 128ac′, all locations within the section of the subregion 118a to be solidified, which section is bounded by the boundary 118ab and the line 1118, can be scanned.

A method and device for generating a control data set, which implement the procedure just described in connection with FIGS. 11a and 11b, are analogous to the method and device described in connection with FIGS. 9 and 10, which is why their description will not be repeated here. It should only be mentioned that the check as to whether an interruption period Δt exceeds a permissible interruption time span tₘₐₓ can be carried out in a test unit 108, which is arranged in the device 100 for generating a control data set.

The procedure described in connection with FIGS. 11a and 11b only needs to be carried out if the interruption period Δt exceeds a permissible interruption time span tₘₐₓ, since for short interruption periods Δt the cooling of the already scanned building material is not yet extensive enough to cause shrinkage effects. The length of the still permissible interruption time span tₘₐₓ can be determined, for example, by carrying out a few preliminary tests with the targeted building material before starting the actual manufacturing process with the additive manufacturing device. If the interruption period Δt exceeds the permissible interruption time span tₘₐₓ, a resulting minimum distance 1118 to the boundary 118ab must be specified in the method for generating a control data set (the minimum distance is denoted here as the line with the reference sign 1118). Here, the value of the minimum distance is predefined depending on the length of the interruption period. The relationship between the two parameters can in turn be determined by a few preliminary tests with the targeted building material before the start of the actual manufacturing process with the additive manufacturing device.

FIG. 12 shows a variant of the procedure illustrated in FIG. 11b. In the example of FIG. 12, the line 1118 denoting the minimum distance lies between the boundary 118ab and the trajectory 128ac closest to the boundary in the subregion 118a to be solidified. Of course, by moving the beam again along the trajectory 128ac, all locations within the section of the subregion 118a to be solidified, which section is delimited by the boundary 118ab and the line 1118, could be scanned. Alternatively, however, energy can be supplied to all these locations with a beam by shifting the trajectory 128ba closest to the boundary 118ab in the subregion 118b to be solidified close enough to the boundary so that, when scanning of the second subregion 118b to be solidified begins, all locations beyond the boundary 118ab that are closer to the boundary 118ab than the minimum distance denoted by the line 1118 are scanned again by moving the beam along the trajectory 128ba.

FIG. 13 shows another variant of the procedure illustrated in FIG. 11b. In the example of FIG. 13, the trajectories do not extend parallel, but perpendicular to the boundary 118ab (an extension at an angle other than 90° would also be possible). In the example of FIG. 13, the locations of the subregion 118a to be solidified that are located within the minimum distance 1118 to the boundary 118ab are not all scanned before the scanning of the subregion 118b to be solidified, but in the course of the scanning of the subregion 118b to be solidified, namely by extending the trajectories in the subregion 118b to be solidified beyond the boundary 118ab to the line 1118 in the first subregion 118a to be solidified.

It should also be mentioned that in FIG. 13, the trajectories in the subregion 118b to be solidified are shifted horizontally relative to the trajectories in the subregion 118a to be solidified only for reasons of better representation. In fact, the trajectories in the subregion 118b to be solidified can also have a different horizontal position than that shown in the figure. In particular, the trajectories in the subregion 118b to be solidified can have the same horizontal position as the trajectories in the subregion 118a to be solidified, so that the trajectories of one subregion to be solidified continue in the other region (which refers to the location and is not intended to mean that the subregions to be solidified are scanned with temporal overlap, i.e. without an interruption period Δt in between).

Apart from the explicitly described procedure for the variants in FIG. 12 and FIG. 13, everything said in connection with FIGS. 11a and 11b also applies to the variants in FIG. 12 and FIG. 13.

FIG. 14 shows a schematic view of the build area 8 vertically from above to illustrate a fourth exemplary embodiment. In the fourth exemplary embodiment, a square object cross-section 200 is present in the build area 8 as an example, in the middle of which a recess 210, which is also square, is present where the building material is not to be solidified. The reference sign 250 in the figure indicates the inner contour line of the object cross-section 200 to be solidified, i.e. the inner edge region bordering on the square recess 210.

In the present exemplary embodiment, in order to solidify the object cross-section, it is divided into four subregions 148a, 148b, 148c and 148d to be solidified, of which the subregions 148a and 148b to be solidified adjoin each other at a boundary 148ab, the subregions 148a and 148c to be solidified adjoin each other at a boundary 148ac, the subregions 148b and 148d to be solidified adjoin each other at a boundary 148bd and the subregions 148c and 148d to be solidified adjoin each other at a boundary 148cd.

It is assumed here that first the subregion 148a to be solidified is scanned with a beam, then the subregion 148b to be solidified, then the subregion 148c to be solidified and finally the subregion 148d to be solidified. As a result, there is an interruption period Δt_{ac} between the end of the scanning of the subregion 148a to be solidified and the start of the scanning of the subregion 148c to be solidified, and there is an interruption period Δt_{bd} between the end of the scanning of the subregion 148b to be solidified and the start of the scanning of the subregion 148d to be solidified.

Since the subregion 148b to be solidified is scanned after the subregion 148a to be solidified and the subregion 148d to be solidified is scanned after the subregion 148c to be solidified, it can be assumed, that an interruption period Δt_{ab} between the end of the scanning of the subregion 148a to be solidified and the beginning of the scanning of the subregion 148b to be solidified and an interruption period Δt_{cd} between the end of the scanning of the subregion 148c to be solidified and the beginning of the scanning of the subregion 148d to be solidified are very small and shorter than a permissible interruption time span tₘₐₓ. Therefore, at these boundaries, locations in the subregion to be solidified that was scanned before are not scanned again.

In this exemplary embodiment, it is assumed that a corresponding test unit 108 in a device 100 for generating a control data set determines that the interruption periods Δt_{ac} and Δt_{bd} are each longer than a permissible interruption time span tₘₐₓ. Accordingly, locations in the subregion 148a to be solidified whose distance to the boundary 148ac is smaller than a predetermined minimum distance 1148ac are scanned again before or during the scanning of the subregion 148c to be solidified. Similarly, locations in the subregion 148b to be solidified whose distance to the boundary 148bd is smaller than a predetermined minimum distance 1148bd are scanned again before or during the scanning of the subregion 148d to be solidified. For the sake of simplicity, the same reference signs here denote the respective minimum distances assigned in FIG. 14 to the dashed lines 1148ac and 1148bd illustrating the respective minimum distances. In other words, the minimum distance 1148ac corresponds to the distance that the line 1148ac in FIG. 14 is from the boundary 148ac, and the minimum distance 1148bd corresponds to the distance that the line 1148bd in FIG. 14 is from the boundary 148bd.

In order to scan the region between the line 1148ac and the boundary 148ac again with a beam, it is possible to proceed in the same way as described in connection with FIG. 11b. For this purpose, a beam can thus be moved again along the trajectory 158a indicated in FIG. 14, so that, since the region actually melted is not linear but also extends to the left and right of the trajectory, all locations within the section of the subregion 148a to be solidified delimited by the line 1148ac and the boundary 148ac are also scanned. Basically, however, it is already sufficient to move the beam only along the section 158ac of the trajectory 158a adjacent to the line 1148ac in FIG. 14, which is provided with lateral projections in FIG. 14. Alternatively, analogous to the procedure described in connection with FIG. 12, one could also simply shift the trajectory 158c adjacent to the boundary 148ac closer to the boundary 148ac in the subregion 148c to be solidified, so that by moving the beam along the trajectory 158c all locations beyond the boundary 148ac that are closer to the boundary 148ac than the minimum distance denoted by the line 1148ac are scanned again.

In order to scan the region between the line 1148bd and the boundary 148bd again with a beam, it is also possible to proceed in the same way as described in connection with FIG. 11b. For this purpose, a beam can therefore be moved again along the trajectory 158b indicated in FIG. 14, so that, since the region actually melted is not linear but also extends to the left and right of the trajectory, all locations within the section of the subregion 148b to be solidified delimited by the line 1148bd and the boundary 148bd are also scanned. Again, alternatively, analogous to the procedure described in connection with FIG. 12, one could also simply shift the trajectory 158d adjacent to the boundary 148bd in the subregion 148d to be solidified closer to the boundary 148bd, so that by moving the beam along the trajectory 158d all locations beyond the boundary 148bd that are closer to the boundary 148bd than the minimum distance indicated by the line 1148bd are scanned again.

If the interruption periods Δt_{ac} and Δt_{bd} are of different lengths, this usually also results in different minimum distances 1148ac and 1148bd. In the present case, the interruption period Δt_{ac} corresponds to the time duration required to scan the subregion 148b. The interruption period Δt_{bd} corresponds to the time duration required to scan the subregion 148c. However, since the subregions 148b and 148c have the same area in the present example, it can be assumed that the time durations required for solidifying the subregions 148b and 148c, respectively, are the same if the solidification boundary conditions are otherwise the same, resulting in an approximately equal length of the interruption periods Δt_{ac} and Δt_{bd}. Thus, in the present exemplary embodiment, the minimum distances 1148ac and 1148bd can be chosen to be the same size.

To illustrate a fifth exemplary embodiment, FIG. 15 again shows a schematic view of the build area 8 vertically from above. As in the fourth exemplary embodiment, a square object cross-section 200 is present in the build area 8 as an example, in the center of which a recess 210, which is also square, is present where the building material is not to be solidified. The reference sign 250 in the figure indicates the inner contour line of the object cross-section 200 to be solidified, i.e. the inner edge region bordering on the square recess 210.

The fifth exemplary embodiment illustrates how solidification along the contour line (of the edge region) can also be carried out in an inventive manner. Therefore, no details of the inner region of the object cross-section 200 are shown in FIG. 15. It can, for example, be scanned in the manner described in connection with FIG. 14.

Two trajectories 250a and 250b are shown in FIG. 15, along which a beam is moved along the contour line 250 in order to solidify the building material there. In other words, the contour line is divided into two subregions to be solidified, which are also denoted here by the reference signs 250a and 250b for the sake of simplicity. First, the trajectory 250a is passed through and subsequently the trajectory 250b, wherein the two trajectories each start at a boundary 250ab and meet again at a boundary 250ab′.

In this procedure, an interruption period Δtₛₜₐᵣₜ elapses between the start time of the scanning of the subregion 250a and the start time of the scanning of the subregion 250b. The length of this interruption period Δtₛₜₐᵣₜ corresponds to the time duration required to scan the subregion 250a. When the scanning of the second subregion 250b is started, the building material near the boundary in the subregion 250a has already been able to cool, wherein it is assumed here that the interruption period Δtₛₜₐᵣₜ is greater than a permissible interruption time span tₘₐₓ. Accordingly, the scanning along the trajectory does not start at the boundary 250ab, but in the subregion 250a at a minimum distance 1250 from the boundary 250ab. In this way, undesirable shrinkage at the boundary 250ab can be countered.

At the end of the scanning of the subregion 250b, the beam encounters the previously scanned region 250a at the boundary 250ab′, wherein the locations in the region 250a at the boundary 250ab′ have already been able to cool, since there is an interruption period Δt_{end} between the arrival of the beam at the boundary 250ab′ when scanning the first subregion 250a and the arrival of the beam at the boundary 250ab′ when scanning the second subregion 250b. Accordingly, it makes sense to move the beam beyond the boundary 250ab′ when scanning the second subregion 250b and to scan a section of the first subregion 250a between the boundary 250ab′ and the minimum distance 1250′.

In the present exemplary embodiment, the interruption periods Δtₛₜₐᵣₜ and Δt_{end} are substantially the same size, as the lengths of the trajectories are also the same. For this reason, the minimum distances 1250 and 1250′ are also chosen to be the same in the present exemplary embodiment.

FIGS. 16a and 16b schematically show a further possible embodiment of the procedure illustrated in FIGS. 11b and 12, which is suitable if the trajectories in the first subregion (and also those in the second subregion) are parallel to the boundary 118ab. Similar to FIGS. 11b and 12, FIGS. 16a and 16b show enlarged views of the two sections of the subregions 118a and 118b to be solidified that are adjacent to the boundary 118ab. Here, the trajectories 141a, 141b, 141c in the section 118a of the first subregion to be solidified and the trajectories 142a, 142b, 142c in the section 118b of the second subregion to be solidified lie parallel to the boundary 118ab. In the section 118a, building material is scanned along the trajectories 141a, 141b and 141c, with the trajectory 141c being scanned first, then the trajectory 141b and finally the trajectory 141a. Similarly, building material in the section 118b is scanned along the trajectories 142a, 142b and 142c, with the trajectory 142c being scanned first, then the trajectory 142b and finally the trajectory 142c. It is also assumed that the section 118a is scanned before the section 118b. In particular, the trajectory 141a is scanned as the last trajectory before the beginning of the interruption period Δt and the trajectory 142c is scanned as the first trajectory after the interruption period Δt. There is a distance D between the trajectories in the second subregion 118b and also between the trajectories in the first subregion 118a each. In addition, a distance D′ can be seen between the trajectories 142c and 141a closest to the boundary 118ab in the first and second subregions, which distance D′ is smaller than the distance D, i.e. smaller than the average distance between the other trajectories. This reduced distance D′ was specified because the interruption period between the scanning of the last trajectory 141a in the first subregion 118a and the scanning of the first trajectory 142c in the second subregion 118b had exceeded a permissible interruption time span tₘₐₓ.

Although only six trajectories are shown as an example in FIG. 16a, in practice a subregion is usually scanned using a considerably larger number of trajectories. If all trajectories except those closest to the boundary between the first and second subregions are separated by a distance D, the average distance between the trajectories is substantially equal to D. The distance D′ between the trajectories 141a and 142c is therefore smaller than the average distance D between the trajectories of the first and second subregions.

FIG. 16b shows, in analogy to FIG. 16a, the sections 118a of the first subregion and 118b of the second subregion, the trajectories 142a, 142b, 142c, 141a, 141b and 141c and the boundary 118ab. The example of FIG. 16b is intended to illustrate that the procedure in which all locations in the first subregion whose distance to the boundary (118ab) is smaller than a predetermined minimum distance (1118) are scanned again before the start of scanning or when scanning the locations of the second subregion (118b) to be solidified can also be described by reducing the distance between the trajectories closest to the boundary.

As can be seen in FIG. 16b, the trajectory 142c actually belonging to the second subregion 118b is located in the first subregion 118a at a smaller distance d2 from the boundary 118ab larger than the distance d1 that the trajectory 141a has from the boundary 118ab. Nevertheless, the distance D′ between the trajectories 141a and 142c is smaller than the average distance D of the trajectories of the first and second subregions. By positioning the trajectory 142c in the first subregion 118a, it is thus possible to automatically ensure that all locations in the first subregion (118a) to be solidified whose distance to the boundary (118ab) is smaller than a predetermined minimum distance (1118) are scanned again before the start of scanning or when scanning the locations of the second subregion (118b) to be solidified. Note that in the example of FIG. 16b, the locations in the first subregion 118a directly at the boundary 118ab are first scanned by means of the trajectory 142b.

A method and a device for generating a control data set, which implement the procedure just described in connection with FIGS. 16a and 16b, are analogous to the method and device described in connection with FIGS. 9 and 10, and their description will therefore not be repeated here.

The procedure described in connection with FIGS. 16a and 16b only needs to be carried out if the interruption period Δt exceeds a permissible interruption time span tₘₐₓ, since for short interruption periods Δt the cooling of the already scanned building material is not yet extensive enough to cause shrinkage effects. The length of the still permissible interruption time span tₘₐₓ can be determined, for example, by a few preliminary tests with the targeted building material before starting the actual manufacturing process with the additive manufacturing device. If the interruption period Δt exceeds the permissible interruption time span tₘₐₓ, a distance D′ between the trajectories 141a and 142c is determined in the method for generating a control data set. The distance D′ can be related, in particular in a mathematical relationship, to the interruption period Δt. The relationship between the two parameters can in turn be determined by a few preliminary tests with the targeted building material before starting the actual manufacturing process with the additive manufacturing device.

1. A computer-aided method for generating a control data set for an energy input device of an additive manufacturing device for manufacturing a three-dimensional object by means of the same,
wherein the additive manufacturing device is adapted to manufacture the object by applying a building material layer by layer and solidifying the building material in a build area by means of the energy input device by supplying radiation energy to solidification positions in each layer which are associated with the cross-section of the object in this layer,
wherein the energy input device comprises a number of beam emitters above the build area, from which a number of beams are directed to the build area,
the method comprising the following steps:
a first step of accessing computer-based model data of an object cross-section of the object to be manufactured,
a second step of generating a data model of a region of a building material layer to be solidified for the manufacture of the object cross-section,
wherein in the data model, a scanning of locations of the region to be solidified by moving a beam along a plurality of trajectories in the build area is specified,
wherein in the data model the region of the building material layer to be solidified is divided into a plurality of subregions to be solidified, to each of which subregions a beam is directed,
wherein there are at least a first subregion to be solidified and a second subregion to be solidified, which adjoin each other in the build area at a boundary,
wherein it is specified that locations to be solidified in the first subregion to be solidified are scanned at a time coordinated with locations to be solidified in the second subregion to be solidified, and
a third step in which the control data set for the energy input device is generated taking into account the data model generated in the second step.

2. (canceled)

3. The method according to claim 1, wherein locations to be solidified in the first subregion to be solidified are scanned with a maximum time interval to locations to be solidified in the second subregion to be solidified, which maximum time interval is less than or equal to 10 ms.

4-7. (canceled)

8. The method according to claim 1, wherein pairs of locations on both sides of the boundary whose distance to each other is less than 3 times the beam width of the beam in the first subregion to be solidified, are solidified at a time coordinated with one another.

9. The method according to claim 1, wherein the method is applied to object cross-sections which comprise a downwardly facing surface region of the object during the solidification of four object cross-sections directly above an object cross-section having a surface region facing downward during manufacture.

10. The method according to claim 1,
wherein a scanning of the locations of the region of the building material layer to be solidified is specified subregion by subregion,
wherein it is specified that after a scanning of the locations of the first subregion to be solidified at the boundary, the scanning of the locations of the second subregion to be solidified at the boundary, is started only after the end of an interruption period,
wherein if the interruption period exceeds a permissible interruption time span, the scanning of the locations of the region to be solidified is specified such that a distance between the trajectory closest to the boundary in the first subregion to be solidified and the trajectory closest to the boundary in the second subregion to be solidified is smaller than an average distance between the trajectories in the first subregion to be solidified and/or between the trajectories in the second subregion to be solidified; and/or
all locations in the first subregion to be solidified whose distance to the boundary is smaller than a predetermined minimum distance are scanned again before the start of the scanning or during the scanning of the locations of the second subregion to be solidified.

11-14. (canceled)

15. A method for controlling an energy input device of an additive manufacturing device for manufacturing a three-dimensional object by means of the same,
wherein the additive manufacturing device is adapted to manufacture the object by applying a building material layer by layer and solidifying the building material in a build area by means of the energy input device by supplying radiation energy to solidification positions in each layer which are associated with the cross-section of the object in this layer,
wherein the energy input device comprises, above the build area, a first beam emitter from which a first beam is directed to the build area and a second beam emitter from which a second beam is directed to the build area,
the first beam emitter being assigned a first working region in the build area to which the first beam can be directed, and the second beam emitter being assigned a second working region in the build area to which the second beam can be directed,
wherein the first and second working regions adjoin each other at a boundary,
wherein the solidification positions of a layer in the first and second working regions are each scanned by moving the first and second beams, respectively, along a plurality of trajectories in the build area,
wherein the energy input device is controlled such that locations to be solidified in the first working region are scanned at a time coordinated with locations to be solidified in the second working region.

16. The method according to claim 6, wherein locations to be solidified at the boundary in the first working region are scanned with a previously determined material- and/or process-specific maximum time interval to locations to be solidified at the boundary in the second working region.

17. The method according to claim 6, wherein locations to be solidified in the first working region are scanned with a maximum time interval to locations to be solidified in the second working region, which maximum time interval is less than or equal to 10 ms.

18-24. (canceled)

25. The method according to claim 6, wherein, in the case of the presence of a plurality of non-contiguous object cross-sectional regions each covering the boundary, a waiting time is provided in at least one of the two working regions after and/or before a substantially complete scanning of an object cross-sectional region.

26. The method according to claim 6, wherein pairs of locations on both sides of the boundary whose distance to each other is less than 3 times the beam width of the first beam in the first working region, are solidified at a time coordinated with one another.

27. The method according to claim 6, wherein the scanning directions of the trajectories in a second layer subsequent to a first layer are rotated by an angle with respect to those of the first layer, wherein the direction of rotation in the first working region is opposite to the direction of rotation in the second working region.

28. The method according to claim 6, wherein the method is applied in the solidification of four object cross-sections directly above an object cross-section having a surface region facing downward during manufacture.

29. An additive manufacturing method for manufacturing a three-dimensional object, the object being manufactured by means of an additive manufacturing device by applying a building material layer by layer and solidifying the building material in a build area by means of an energy input device by supplying radiation energy to solidification positions in each layer which are associated with the cross-section of the object in this layer,
wherein the energy input device comprises above the build area a first beam emitter from which a first beam is directed to the build area and a second beam emitter from which a second beam is directed to the build area,
the first beam emitter being assigned a first working region in the build area to which the first beam can be directed, and the second beam emitter being assigned a second working region in the build area to which the second beam can be directed,
wherein the first and second working regions adjoin each other at a boundary,
wherein the solidification positions of a layer in the first and second working regions are each scanned by moving the first and second beams, respectively, along a plurality of trajectoris in the build area,
wherein the energy input device is controlled by means of a method according to claim 6.

30-31. (canceled)

32. A control device of an energy input device of an additive manufacturing device for manufacturing a three-dimensional object by means of the same,
wherein the additive manufacturing device is adapted to manufacture the object by applying a building material layer by layer and solidifying the building material in a build area by means of the energy input device by supplying radiation energy to solidification positions in each layer which are associated with the cross-section of the object in this layer,
wherein the energy input device comprises above the build area a first beam emitter from which a first beam is directed to the build area and a second beam emitter from which a second beam is directed to the build area,
the first beam emitter being assigned a first working region in the build area to which the first beam can be directed, and the second beam emitter being assigned a second working region in the build area to which the second beam can be directed,
wherein the first and second working regions adjoin each other at a boundary,
wherein the control device comprises a scanning control unit that is configured to cause the energy input device to scan the solidification positions in the first and second working regions by moving the first and second beams, respectively, along a plurality of trajectories in the build area,
wherein the scanning control unit coordinates the movements of the first and second beams so that locations to be solidified in the first working region are scanned at a time coordinated with locations to be solidified in the second working region.

33. An additive manufacturing device for manufacturing a three-dimensional object, the object being manufactured by means of the additive manufacturing device by applying a building material layer by layer and solidifying the building material in a build area by means of an energy input device by supplying radiation energy to solidification positions in each layer which are associated with the cross-section of the object in this layer, wherein the additive manufacturing device comprises:
a layer application device suitable for applying a layer of a building material to an already existing building material layer, and
an energy input device suitable for supplying radiation energy to solidification positions in each layer that are associated with the cross-section of the object in this layer, wherein the energy input device comprises above the build area a first beam emitter from which a first beam can be directed to the build area and a second beam emitter from which a second beam can be directed to the build area,
the first beam emitter being assigned a first working region in the build area to which the first beam can be directed, and the second beam emitter being assigned a second working region in the build area to which the second beam can be directed,
wherein the first and second working regions adjoin each other at a boundary,
wherein the solidification positions of a layer in the first and second working regions are each scanned by moving the first and second beams, respectively, along a plurality of trajectories in the build area,
wherein the additive manufacturing device comprises a device according to claim 14 or is connected in terms of signalling to a device according to claim 14.
